(19) United States
(12) Patent Application Publication
(10) Pub. No.: US 2021/0174397 A1
(43) Pub. Date: Jun. 10, 2021

(54) INFORMATION PROVIDING SYSTEM, TERMINAL DEVICE, INFORMATION DISTRIBUTING DEVICE, INFORMATION PROVIDING METHOD, AND COMPUTER PROGRAM

(71) Applicant: KDDI CORPORATION, Tokyo (JP)

(72) Inventors: Keisuke TAKEMORI, Tokyo (JP); Seiichirou MIZOGUCHI, Tokyo (JP); Teruaki HONMA, Tokyo (JP); Hiroshi ISHIZUKA, Tokyo (JP); Akinori TOTSUKA, Tokyo (JP)

(73) Assignee: KDDI CORPORATION, Tokyo (JP)

(21) Appl. No.: 15/734,410

(22) PCT Filed: Jun. 4, 2019
(86) PCT No.: PCT/JP2019/022128

§ 371 Date: Dec. 2, 2020

(30) Foreign Application Priority Data
Jun. 4, 2018 (JP) 2018-106881
Jun. 28, 2018 (JP) 2018-123597
Jul. 6, 2018 (JP) 2018-129422

(51) Int. Cl. G06Q 30/02; G01C 21/36; H04W 4/40

(52) U.S. Cl. CPC G06Q 30/0266; G06Q 30/0267; H04W 4/40; G01C 21/3655; G01C 21/362; G01C 21/3697

(57) ABSTRACT

An information distributing device includes a provision information transmitting unit configured to transmit provision information to be provided to a user of a terminal device to the terminal device. The terminal device includes a vehicle interface configured to communicate with a vehicle, a vehicle information acquiring unit configured to acquire parking state information indicating whether or not the vehicle has parked through the vehicle interface, and a provision control unit configured to control whether or not the provision information is to be displayed on a display screen of the terminal device on the basis of the parking state information.

### TECHNICAL FIELD

The present invention relates to an information providing system, a terminal device, an information distributing device, an information providing method, and a computer program.

Furthermore, the present invention relates to an information processing device, a navigation method, and an integrated database device.

Priority is claimed on Japanese Patent Application No. 2018-106881, filed Jun. 4, 2018, Japanese Patent Application No. 2018-123597, filed Jun. 28, 2018, and Japanese Patent Application No. 2018-129422, filed Jul. 6, 2018, the contents of which are incorporated herein by reference.

### BACKGROUND ART

Conventionally, information providing technology for displaying and presenting coupons for discounts and the like that can be used in a shop for a driver of an automobile on a display device of a user interface of the automobile is known (see, for example, Patent Document 1).

### PRIOR ART DOCUMENT

### Patent Document

### [Patent Document 1]

Published Japanese Translation No. 2012-503468 of the PCT International Publication

### SUMMARY OF INVENTION

### Problems to be Solved by the Invention

In the conventional information providing technology described above, there is a possibility that coupons and the like will be presented while the driver of the automobile is driving. If the coupons are presented while the driver is driving, the presentation may interfere with the driving. Thus, there is a demand for technology for presenting provision information about coupons and the like to a driver of an automobile at an appropriate timing.

Also, in the above-described conventional device, a process of guiding customers to shops where coupons are available is not taken into account.

Furthermore, an advertiser of provision information expects the customer guiding effect of guiding an occupant of an automobile to the advertiser's shop, service facility, or the like by presenting the provision information about coupons and the like to an occupant such as a driver or a fellow passenger in the automobile. However, the above-described conventional information providing technology does not consider the presentation of provision information about coupons and the like suitable for occupants of automobiles, which may be insufficient for the customer guiding effect expected by the advertiser of the provision information. Also, there is a problem that it is difficult to efficiently acquire information that is referred to when provision information about coupons and the like suitable for an occupant of an automobile is selected.

The present invention has been made in consideration of such circumstances and an objective of the present invention is to present provision information about coupons and the like to a driver of a vehicle such as an automobile at an appropriate timing.

Furthermore, an objective of the present invention is to contribute to guiding customers according to provision information about coupons and the like.

### Means for Solving the Problems

(1) According to an aspect of the present invention, there is provided an information providing system including: a terminal device; and an information distributing device, wherein the information distributing device includes a provision information transmitting unit configured to transmit provision information to be provided to a user of the terminal device to the terminal device, and wherein the terminal device includes a vehicle interface configured to communicate with a vehicle; a vehicle information acquiring unit configured to acquire parking state information indicating whether or not the vehicle has parked through the vehicle interface; and a provision control unit configured to control whether or not the provision information is to be displayed on a display screen of the terminal device on the basis of the parking state information.

(2) According to an aspect of the present invention, there is provided an information providing system including: a terminal device; and an information distributing device, wherein the terminal device includes a vehicle interface configured to communicate with a vehicle; a vehicle information acquiring unit configured to acquire parking state information indicating whether or not the vehicle has parked through the vehicle interface; and a parking state information transmitting unit configured to transmit the parking state information to the information distributing device, and wherein the information distributing device includes a provision information transmitting unit configured to transmit provision information to be provided to a user of the terminal device to the terminal device; and a provision control unit configured to control whether or not the provision information is to be displayed on a display screen of the terminal device on the basis of the parking state information.

(3) In the information providing system according to the aspect of the present invention, the provision control unit may control a transmission timing at which the provision information transmitting unit transmits the provision information to the terminal device.

(4) The information providing system according to the aspect of the present invention may further include a user type information acquiring unit configured to acquire user type information indicating whether or not the user is a driver of the vehicle, wherein the provision control unit may perform control so that the provision information is not displayed on the display screen of the terminal device when the parking state information indicates that the vehicle has not parked if the user type information indicates that the user is the driver of the vehicle.

(5) According to an aspect of the present invention, there is provided a terminal device including: a provision information receiving unit configured to receive provision information to be provided to a user of the terminal device from an information distributing device; a vehicle interface configured to communicate with a vehicle; a vehicle information acquiring unit configured to acquire parking state information indicating whether or not the vehicle has parked through the vehicle interface; and a provision control unit configured to control whether or not the provision information is to be displayed on a display unit of the terminal device on the basis of the parking state information.

(6) According to an aspect of the present invention, there is provided an information distributing device including: a parking state information receiving unit configured to receive parking state information indicating whether or not a vehicle has parked acquired by a terminal device communicating with the vehicle from the terminal device; a provision information transmitting unit configured to transmit provision information to be provided to a user of the terminal device to the terminal device; and a provision control unit configured to control whether or not the provision information is to be displayed on a display screen of the terminal device on the basis of the parking state information.

(7) According to an aspect of the present invention, there is provided an information providing method including: a provision information receiving step in which a terminal device receives provision information to be provided to a user of the terminal device from an information distributing device; a vehicle information acquiring step in which the terminal device communicates with a vehicle and acquires parking state information indicating whether or not the vehicle has parked; and a provision control step in which the terminal device controls whether or not the provision information is to be displayed on a display unit of the terminal device on the basis of the parking state information.

(8) According to an aspect of the present invention, there is provided an information providing method including: a parking state information receiving step in which an information distributing device receives parking state information indicating whether or not a vehicle has parked acquired by a terminal device communicating with the vehicle from the terminal device; a provision information transmitting step in which the information distributing device transmits provision information to be provided to a user of the terminal device to the terminal device; and a provision control step in which the information distributing device controls whether or not the provision information is to be displayed on a display screen of the terminal device on the basis of the parking state information.

(9) According to an aspect of the present invention, there is provided a computer program for causing a computer to implement: a provision information receiving function of receiving provision information to be provided to a user of a terminal device from an information distributing device; a vehicle interface function of communicating with a vehicle; a vehicle information acquiring function of acquiring parking state information indicating whether or not the vehicle has parked through the vehicle interface function; and a provision control function of controlling whether or not the provision information is to be displayed on a display unit of the terminal device on the basis of the parking state information.

(10) According to an aspect of the present invention, there is provided a computer program for causing a computer to implement: a parking state information receiving function of receiving parking state information indicating whether or not a vehicle has parked acquired by a terminal device communicating with the vehicle from the terminal device; a provision information transmitting function of transmitting provision information to be provided to a user of the terminal device to the terminal device; and a provision control function of controlling whether or not the provision information is to be displayed on a display screen of the terminal device on the basis of the parking state information.

(11) According to an aspect of the present invention, there is provided a terminal device including: a vehicle interface configured to communicate with a vehicle; and a terminal control unit configured to transmit navigation information based on provision information to the vehicle through the vehicle interface when a user operation of selecting the provision information distributed from an information distributing device to the terminal device has been received.

(12) In the terminal device according to the aspect of the present invention, the terminal control unit may cause the navigation information to be displayed on a display screen of the terminal device when a communication connection with the vehicle through the vehicle interface has not been established.

(13) In the terminal device according to the aspect of the present invention, the navigation information may be information including a destination identified by location information included in the provision information.

(14) In the terminal device according to the aspect of the present invention, the navigation information may be a screen for navigation to the destination.

(15) According to an aspect of the present invention, there is provided an information processing device mounted in a vehicle, the information processing device including: a navigation control unit configured to cause navigation information based on provision information to be displayed on a display screen of the information processing device when a user operation of selecting the provision information distributed to the information processing device has been received from an information distributing device, wherein the navigation control unit executes navigation to a destination identified by location information included in the provision information.

(16) In the information processing device according to the aspect of the present invention, the navigation control unit may transmit the provision information to a terminal device at a timing when the vehicle arrives at the destination.

(17) According to an aspect of the present invention, there is provided a navigation method including: a communication step in which a terminal device communicates with a vehicle; and a terminal control step in which the terminal device transmits navigation information based on provision information to the vehicle when a user operation of selecting the provision information distributed from an information distributing device to the terminal device has been received.

(18) According to an aspect of the present invention, there is provided a navigation method including: a navigation control step in which an information processing device mounted in a vehicle causes navigation information based on provision information to be displayed on a display screen of the information processing device when a user operation of selecting the provision information distributed from an information distributing device to the information processing device has been received, wherein the navigation control step includes executing navigation to a destination identified by location information included in the provision information.

(19) According to an aspect of the present invention, there is provided a computer program for causing a computer of a terminal device to implement: a vehicle interface function of communicating with a vehicle; and a terminal control function of transmitting navigation information based on provision information to the vehicle through the vehicle interface function when a user operation of selecting the provision information distributed from an information distributing device to the terminal device has been received.

(20) According to an aspect of the present invention, there is provided a computer program for causing a computer mounted in a vehicle to implement: a navigation control function of causing navigation information based on provision information to be displayed on a display screen of the computer when a user operation of selecting the provision information distributed from an information distributing device to the computer has been received, wherein the navigation control function includes executing navigation to a destination identified by location information included in the provision information.

(21) According to an aspect of the present invention, there is provided an integrated database device including: a registration information receiving unit configured to receive terminal information registration information in which terminal information including terminal identification information of a terminal device of a user is associated with vehicle identification information of a vehicle and vehicle information registration information in which vehicle information including the vehicle identification information 110 is associated with the terminal identification information; a registration information storing unit configured to store the terminal information registration information and the vehicle information registration information; and a search receiving unit configured to receive searches for the terminal information and the vehicle information stored in the registration information storing unit and respond with search results.

(22) According to an aspect of the present invention, there is provided an information providing system including: the integrated database device according to the above-described aspect (21); and an information distributing device using the integrated database device, wherein the information distributing device includes a provision information storing unit configured to store a plurality of pieces of provision information to be distributed for guiding customers; a provision information acquiring unit configured to acquire the terminal information including the terminal identification information of the terminal device of the user and the vehicle information associated with the terminal identification information or the vehicle information including the vehicle identification information of the vehicle of the user and the terminal information associated with the vehicle identification information from the integrated database device and select provision information to be provided to the user from among the plurality of pieces of provision information of the provision information storing unit on the basis of the terminal information and the vehicle information that have been acquired; and a provision information transmitting unit configured to transmit the provision information to be provided to the user.

(23) In the information providing system according to the aspect of the present invention, the provision information acquiring unit may monitor a change in the terminal identification information associated with the vehicle information including the same vehicle identification information, determine whether or not vehicle information of a monitoring target is vehicle information about a plurality of users on the basis of a monitoring result, and select provision information corresponding to a plurality of users from among the plurality of pieces of provision information of the provision information storing unit on the basis of vehicle information of the monitoring target when it is determined that the vehicle information of the monitoring target is the vehicle information about the plurality of users.

(24) According to an aspect of the present invention, there is provided a computer program for causing a computer to implement: a registration information receiving function of receiving terminal information registration information in which terminal information including terminal identification information of a terminal device of a user is associated with vehicle identification information of a vehicle and vehicle information registration information in which vehicle information including the vehicle identification information is associated with the terminal identification information; and a registration information storing function of storing the terminal information registration information and the vehicle information registration information.

(25) According to an aspect of the present invention, there is provided a computer program for causing an information distributing computer of an information providing system including the integrated database device according to the above-described aspect (21) to implement: a provision information storing function of storing a plurality of pieces of provision information to be distributed for guiding customers; a provision information acquiring function of acquiring the terminal information including the terminal identification information of the terminal device of the user and the vehicle information associated with the terminal identification information or the vehicle information including the vehicle identification information of the vehicle of the user and the terminal information associated with the vehicle identification information from the integrated database device and selecting provision information to be provided to the user from among the plurality of pieces of provision information of the provision information storing function on the basis of the terminal information and the vehicle information that have been acquired; and a provision information transmitting function of transmitting the provision information to be provided to the user.

(26) According to an aspect of the present invention, there is provided a database generating method including: a registration information receiving step in which an integrated database device receives terminal information registration information in which terminal information including terminal identification information of a terminal device of a user is associated with vehicle identification information of a vehicle and vehicle information registration information in which vehicle information including the vehicle identification information is associated with the terminal identification information; and a registration information storing step in which the integrated database device stores the terminal information registration information and the vehicle information registration information.

(27) According to an aspect of the present invention, there is provided an information providing method including: a step in which the integrated database device according to the above-described aspect (21) is provided; a provision information storing step in which an information distributing device stores a plurality of pieces of provision information to be distributed for guiding customers in a provision information storing unit; a provision information acquiring step in which the information distributing device acquires the terminal information including the terminal identification information of the terminal device of the user and the vehicle information associated with the terminal identification information or the vehicle information including the vehicle identification information of the vehicle of the user and the terminal information associated with the vehicle identification information from the integrated database device and selects provision information to be provided to the user from among the plurality of pieces of provision information of the provision information storing unit on the basis of the terminal information and the vehicle information that have been acquired; and a provision information transmitting step in which the information distributing device transmits the provision information to be provided to the user.

### Advantageous Effects of the Invention

According to the present invention, it is possible to present provision information about coupons and the like to a driver of a vehicle such as an automobile at an appropriate timing.

Furthermore, according to the present invention, it is possible to contribute to the improvement of the customer guiding effect according to provision information about coupons and the like.

### BRIEF DESCRIPTION OF DRAWINGS

FIG. 1 is a configuration diagram of an information providing system according to a first embodiment.

FIG. 2 is a block diagram showing a functional configuration of an information provision control unit according to the first embodiment.

FIG. 3 is a block diagram showing a functional configuration of an information distributing device according to the first embodiment.

FIG. 4 is a block diagram showing a functional configuration of a terminal device according to the first embodiment.

FIG. 5 is a block diagram showing a functional configuration of IVI equipment according to the first embodiment.

FIG. 6 is a flowchart showing an example of a procedure of an information providing method according to first and second embodiments.

FIG. 7 is a flowchart showing another example of the procedure of the information providing method according to the first and second embodiments.

FIG. 8 is a configuration diagram of an information providing system according to the second embodiment.

FIG. 9 is a block diagram showing a functional configuration of an information distributing device according to the second embodiment.

FIG. 10 is a block diagram showing a functional configuration of a terminal device according to the second embodiment.

FIG. 11 is a configuration diagram of an information providing system according to a third embodiment.

FIG. 12 is a configuration diagram of an information providing system according to a fourth embodiment.

FIG. 13 is a block diagram showing a functional configuration of an information distributing device according to the fourth embodiment.

FIG. 14 is a block diagram showing a functional configuration of a terminal device according to the fourth embodiment.

FIG. 15 is a block diagram showing a functional configuration of IV′ equipment according to the fourth embodiment.

FIG. 16 is a diagram showing an example of a procedure of a navigation method according to the fourth embodiment.

FIG. 17 is a flowchart showing another example of the navigation method according to the fourth embodiment.

FIG. 18 is a configuration diagram of an information providing system according to a fifth embodiment.

FIG. 19 is a block diagram showing a functional configuration of a terminal device according to the fifth embodiment.

FIG. 20 is a block diagram showing a functional configuration of IVI equipment according to the fifth embodiment.

FIG. 21 is a flowchart showing a procedure of a navigation method according to the fifth embodiment.

FIG. 22 is a configuration diagram showing an information providing system according to a sixth embodiment.

FIG. 23 is a configuration diagram of an information providing system according to a seventh embodiment.

FIG. 24 is a block diagram showing a functional configuration of an integrated database device according to the seventh embodiment.

FIG. 25 is a block diagram showing a functional configuration of a terminal device according to the seventh embodiment.

FIG. 26 is a block diagram showing a functional configuration of an automobile according to the seventh embodiment.

FIG. 27 is a block diagram showing a functional configuration of an information distributing device according to the seventh embodiment.

FIG. 28 is a table showing a registration information storing unit of the integrated database device according to the seventh embodiment.

FIG. 29 is a diagram showing a procedure of example 1 of a database generating method according to the seventh embodiment.

FIG. 30 is a diagram showing a procedure of example 2 of the database generating method according to the seventh embodiment.

FIG. 31 is a diagram showing a procedure of example 3 of the database generating method according to the seventh embodiment.

FIG. 32 is a flowchart showing a procedure of an information providing method according to the seventh embodiment.

FIG. 33 is a flowchart showing a procedure of example 2 of a provision information selecting method according to the seventh embodiment.

FIG. 34 is a configuration diagram showing an information providing system according to the seventh embodiment.

### EMBODIMENTS FOR CARRYING OUT THE INVENTION

Hereinafter, embodiments of the present invention will be described with reference to the drawings. In the embodiments shown below, an automobile will be described as an example of a vehicle.

### First Embodiment

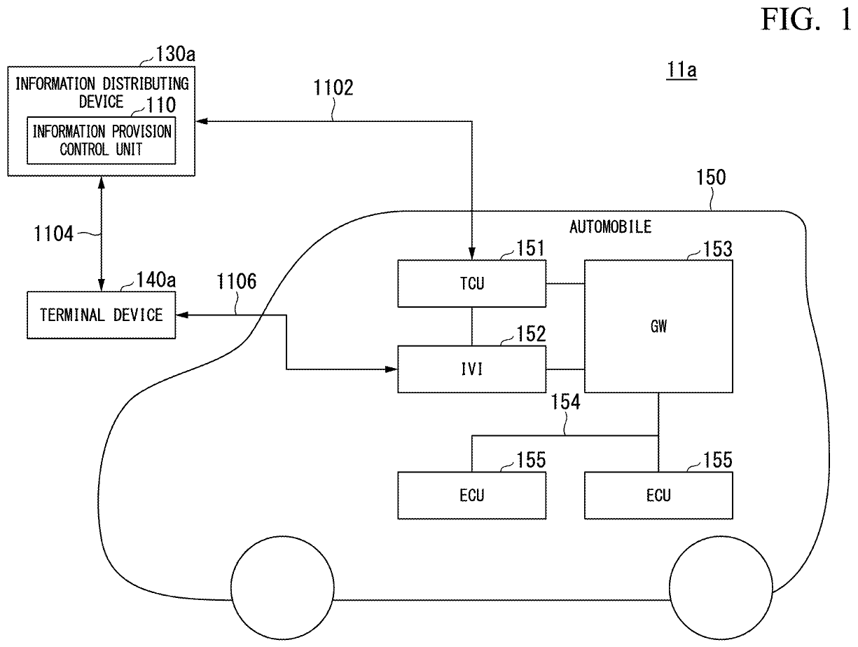

FIG. 1 is a schematic configuration diagram of an information providing system according to a first embodiment. In FIG. 1, an information providing system 11a includes an information distributing device 130a, a terminal device 140a, and an automobile 150. The information distributing device 130a includes an information provision control unit 110. The terminal device 140a may be inside an automobile 150, or may be outside the automobile 150.

The automobile 150 includes a tele communication unit (TCU) 151, in-vehicle infotainment (IVI) equipment 152, a gateway (GW) device 153, a communication network 154, and a plurality of electronic control units (ECUs) 155.

The ECU 155 is an in-vehicle computer provided in the automobile 150. The ECU 155 has a control function such as engine control of the automobile 150. Examples of the ECU 155 include an ECU having an engine control function, an ECU having a transmission control function, an ECU having a steering wheel control function, an ECU having a brake control function, and the like. The GW device 153 has a function of security of data applied to the ECU 155 mounted in the automobile 150.

The GW device 153 and the plurality of ECUs 155 are connected to a communication network (hereinafter referred to as an in-vehicle network) 154 provided in the automobile 150. The in-vehicle network 154 may be, for example, a controller area network (CAN). The CAN is known as an example of a communication network mounted in a vehicle. The GW device 153 exchanges data with each ECU 155 via the in-vehicle network 154. The ECU 155 exchanges data with another ECU 155 via the in-vehicle network 154.

Also, the automobile 150 is provided with a communication network other than the CAN as the in-vehicle network 154 and the exchange of data between the GW device 153 and the ECU 155 and the exchange of data between the ECUs 155 via the communication network other than the CAN may be performed. For example, a local interconnect network (LIN) may be provided in the automobile 150. Also, the CAN and the LIN may be provided in the automobile 150.

The TCU 151 is connected to the IVI equipment 152 and the GW device 153. The TCU 151 is a communication device. In the first embodiment, the TCU 151 performs communication using a wireless communication network. For example, the TCU 151 may communicate with the information distributing device 130a via the wireless communication network. For example, the TCU 151 may communicate with the terminal device 140a present inside or outside the automobile 150 via the wireless communication network.

The IVI equipment 152 includes, for example, a navigation function, a location information service function, a multimedia playback function for music, moving images, and the like, a voice communication function, a data communication function, an Internet connection function, and the like. The IVI equipment 152 includes input devices such as a keyboard, a numeric keypad, and a mouse for inputting data according to a user's operation and a display device such as a liquid crystal display device for displaying data. The IVI equipment 152 may include a touch panel capable of performing both a data input operation and a data display operation.

The IVI equipment 152 is connected to the TCU 151 and the GW device 153. The IVI equipment 152 communicates with the ECU 155 via the GW device 153. Also, the IVI equipment 152 acquires vehicle information of the automobile 150 flowing through the in-vehicle network 154 via the GW device 153.

Also, the IVI equipment 152 has a short-range wireless communication function. For example, short-range wireless communication may be wireless communication of a wireless local area network (LAN) such as “Wi-Fi (registered trademark)” or may be wireless communication of “Bluetooth (registered trademark)” such as BLE. The IVI equipment 152 may communicate with the terminal device 140a through the short-range wireless communication. Also, the IVI equipment 152 may communicate with the terminal device 140a and the information distributing device 130a via the TCU 151.

Also, the IVI equipment 152 includes a terminal interface for cooperating with the terminal device 140a. The terminal interface has a function of displaying a screen generated by an application of the terminal device 140a on the display device of the IVI equipment 152, a function of transmitting vehicle information of the automobile 150 to the terminal device 140a, and the like. Through the terminal interface, for example, gear information, which is an example of vehicle information of the automobile 150, can be transmitted to the terminal device 140a. The gear information is vehicle information indicating the state of a gear of a transmission of the automobile 150. The terminal device 140a can recognize whether or not the gear of the transmission of the automobile 150 is in a “parked” state according to gear information received from the automobile 150.

The information distributing device 130a communicates with the TCU 151 of the automobile 150 via the communication path 1102. The information distributing device 130a communicates with a device mounted in the automobile 150 via the TCU 151 of the automobile 150. The communication path 1102 is a communication path including a wireless communication path of the wireless communication network used by the TCU 151. The communication path 1102 may include a wireless communication path and a wired communication path. The communication path 1102 may be, for example, a communication path including the wireless communication network used by the TCU 151 and the Internet.

The terminal device 140a may be present inside the automobile 150 or may be present outside the automobile 150. The terminal device 140a communicates with the IVI equipment 152 of the automobile 150 via the communication path 1106. The communication path 1106 may be a communication path for the short-range wireless communication between the terminal device 140a and the IVI equipment 152. The communication path 1106 may be a communication path via the TCU 151. The communication path 1106 may be, for example, a communication path including the wireless communication network used by the TCU 151 and the Internet. The communication path 1106 may include a communication cable. For example, the terminal device 140a and the IVI equipment 152 may be connected by a communication cable and the terminal device 140a and the IVI equipment 152 may transmit and receive data via the communication cable. For example, the terminal device 140a and the IVI equipment 152 may be connected by a Universal Serial Bus (USB) cable and the terminal device 140a and the IVI equipment 152 may perform USB communication via the USB cable.

The information distributing device 130a and the terminal device 140a communicate with each other via the communication path 1104. The communication path 1104 may be a wireless communication path or a wired communication path or may include a wireless communication path and a wired communication path. The communication path 1104 may be, for example, a communication path including the wireless communication network used by the terminal device 140a and the Internet. The wireless communication network used by the terminal device 140a may be a portable phone network or a wireless LAN.

The information distributing device 130a is a device that distributes the provision information to be provided to the user of the terminal device 140a (hereinafter referred to as a terminal user). As an example of the first embodiment, the information distributing device 130a transmits the provision information to the terminal device 140a via the communication path 1104. The provision information is, for example, information about electronic coupons and advertisements with benefits such as discounts that can be used in shops, introductions to service facilities such as gas stations and automobile maintenance shops, route guidance to service facilities, and the like. The information provision control unit 110 performs control when the provision information is provided to the terminal user.

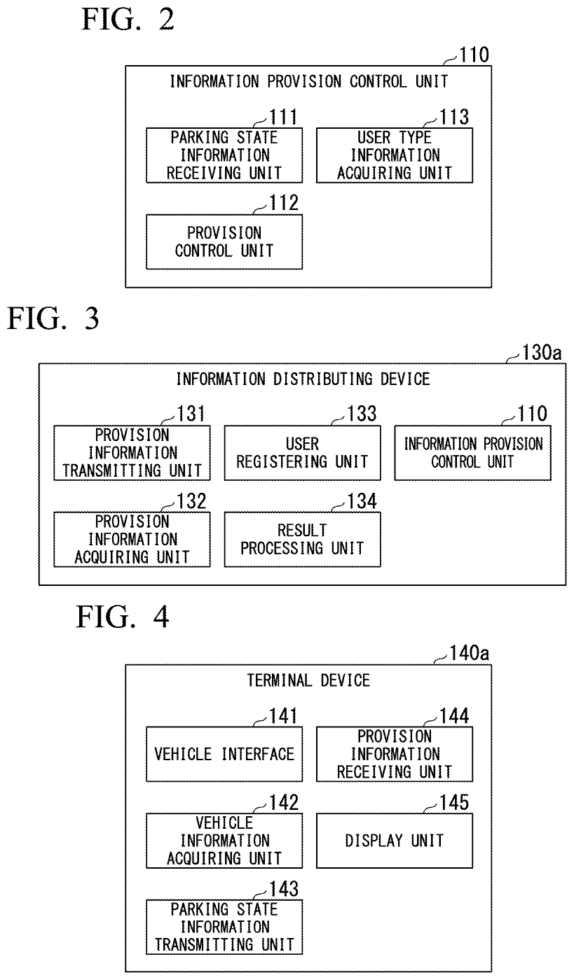

FIG. 2 is a block diagram showing a functional configuration example of the information provision control unit according to the first embodiment. In FIG. 2, the information provision control unit 110 includes a parking state information receiving unit 111, a provision control unit 112, and a user type information acquiring unit 113.

The parking state information receiving unit 111 receives parking state information. The parking state information is information indicating whether or not the automobile 150 has parked. As an example of the first embodiment, the parking state information is the gear information of the automobile 150. When the gear information of the automobile 150 indicates a “parked” state, it is possible to recognize that the automobile 150 has parked. On the other hand, when the gear information of the automobile 150 does not indicate the “parked” state, it is not possible to recognize that the automobile 150 has parked.

The provision control unit 112 controls whether or not the provision information is to be displayed on the display screen of the terminal device 140a on the basis of the parking state information. As an example of the first embodiment, the provision control unit 112 controls a transmission timing at which the information distributing device 130a transmits the provision information to the terminal device 140a.

The user type information acquiring unit 113 acquires user type information indicating whether or not the terminal user is the driver of the automobile 150. Examples of a user type information acquiring method are shown below.

### (Example 1 of User Type Information Acquiring Method)

Whether or not the terminal user is the driver of the automobile 150 is registered in the information distributing device 130a. The information distributing device 130a records the user type information “driver or non-driver” of the registered terminal user. The user type information acquiring unit 113 acquires the user type information “driver or non-driver” of the terminal user recorded in the information distributing device 130a.

### (Example 2 of User Type Information Acquiring Method)

An imaging device capable of imaging the driver's face is provided within the automobile 150 and the IVI equipment 152 transmits a captured driver image captured by the imaging device to the information distributing device 130a through the TCU 151. The information distributing device 130a determines whether or not the terminal user is the driver of the automobile 150 according to matching based on image recognition between a face image of the terminal user registered in advance with the captured driver image received from the automobile 150. The information distributing device 130a records the user type information “driver or non-driver” of the terminal user as a determination result. The user type information acquiring unit 113 acquires the user type information “driver or non-driver” of the terminal user recorded in the information distributing device 130a.

### (Example 3 of User Type Information Acquiring Method)

Example 3 of the user type information acquiring method is a case in which a plurality of immobilizers of the automobile 150 have been issued. For example, a case in which a personal immobilizer is issued to each individual who can drive in the automobile 150 shared by a family and the like may be provided. The IVI equipment 152 transmits immobilizer identification information (an immobilizer ID) of an immobilizer being currently used in the automobile 150 to the information distributing device 130a through the TCU 151. The information distributing device 130a performs matching between the immobilizer ID of the immobilizer of the terminal user registered in advance and the immobilizer ID received from the automobile 150. The information distributing device 130a determines that the terminal user is the driver of the automobile 150 when a matching result indicates a match and determines that the terminal user is not the driver of the automobile 150 when the matching result does not indicate a match. The information distributing device 130a records the user type information “driver or non-driver” of the terminal user as a determination result. The user type information acquiring unit 113 acquires the user type information “driver or non-driver” of the terminal user recorded in the information distributing device 130a.

FIG. 3 is a block diagram showing a functional configuration example of the information distributing device according to the first embodiment. In FIG. 3, the information distributing device 130a includes an information provision control unit 110, a provision information transmitting unit 131, a provision information acquiring unit 132, a user registering unit 133, and a result processing unit 134. The information provision control unit 110 has been described above with reference to FIG. 2.

The provision information transmitting unit 131 transmits the provision information to the terminal device 140a via the communication path 1104 on the basis of control of the transmission timing by the information provision control unit 110. The provision information acquiring unit 132 acquires the provision information to be provided to the terminal user and retains the acquired provision information. The user registering unit 133 records the user registration information of the terminal user. The result processing unit 134 executes result processing for processing a result obtained as a result of providing the provision information to the terminal user.

The information distributing device 130a includes computer hardware such as a central processing unit (CPU) and a memory and a function of the information distributing device 130a is implemented by the CPU executing a computer program stored in the memory. Also, the information distributing device 130a may be configured using a general-purpose computer device or may be configured as a dedicated hardware device.

FIG. 4 is a block diagram showing a functional configuration example of the terminal device according to the first embodiment. FIG. 4 shows a functional configuration related to information provision of the terminal device 140a. In FIG. 4, the terminal device 140a includes a vehicle interface 141, a vehicle information acquiring unit 142, a parking state information transmitting unit 143, a provision information receiving unit 144, and a display unit 145.

The vehicle interface 141 cooperates with the terminal interface of the IVI equipment 152 through communication via the communication path 1106. The vehicle interface 141 has a function of transmitting a terminal application screen generated by the application of the terminal device 140a to the IVI equipment 152 and causing the display device of the IVI equipment 152 to display the terminal application screen through the terminal interface of the IVI equipment 152, a function of receiving vehicle information of the automobile 150 from the terminal interface of the IVI equipment 152, and the like.

The vehicle information acquiring unit 142 acquires the parking state information of the automobile 150 through the vehicle interface 141. As an example of the first embodiment, the vehicle information acquiring unit 142 acquires the gear information of the automobile 150 as the parking state information of the automobile 150 through the vehicle interface 141.

The parking state information transmitting unit 143 transmits the parking state information of the automobile 150 to the information distributing device 130a via the communication path 1104. As an example of the first embodiment, the parking state information transmitting unit 143 transmits the gear information of the automobile 150 serving as the parking state information of the automobile 150 to the information distributing device 130a.

The provision information receiving unit 144 receives the provision information to be provided to the terminal user. As an example of the first embodiment, the provision information receiving unit 144 receives the provision information to be provided to the terminal user from the information distributing device 130a via the communication path 1104.

The display unit 145 displays the provision information. As an example of the first embodiment, the display unit 145 displays the provision information received from the information distributing device 130a by the provision information receiving unit 144.

The terminal device 140a includes computer hardware such as a CPU and a memory and a function of the terminal device 140a is implemented by the CPU executing a computer program stored in the memory. Also, the terminal device 140a may be configured using a general-purpose computer device or may be configured as a dedicated hardware device. Also, a portable communication terminal device such as a smartphone, a tablet-type computer device (a tablet PC), or the like may be used as the terminal device 140a.

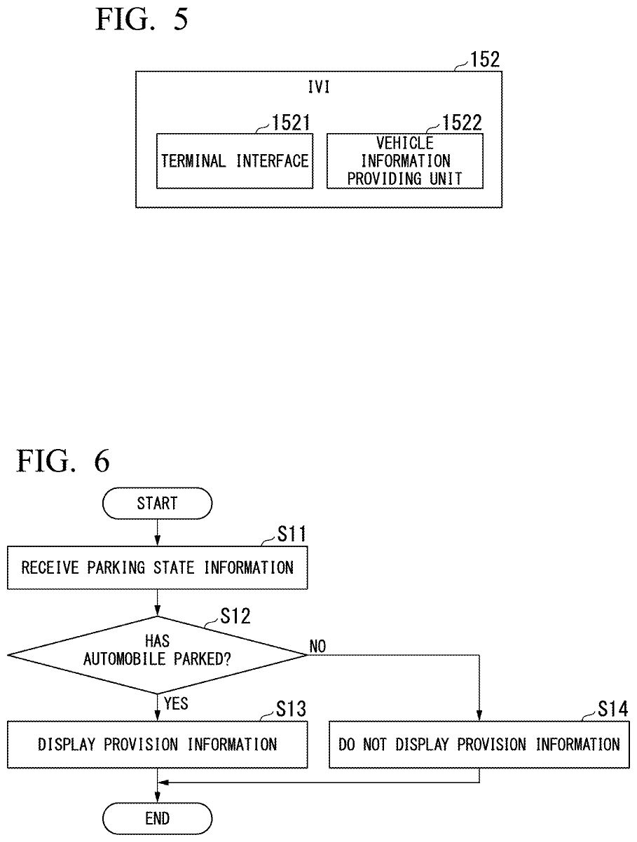

FIG. 5 is a block diagram showing a functional configuration example of the IVI equipment according to the first embodiment. FIG. 5 shows a functional configuration related to information provision of the WI equipment 152. In FIG. 5, the IVI equipment 152 includes a terminal interface 1521 and a vehicle information providing unit 1522.

The terminal interface 1521 cooperates with the vehicle interface 141 of the terminal device 140a through communication via the communication path 1106. The terminal interface 1521 has a function of receiving a terminal application screen generated by the application of the terminal device 140a from the vehicle interface 141 and displaying the received terminal application screen on the display device of the IVI equipment 152, a function of transmitting vehicle information of the automobile 150 to the vehicle interface 141, and the like.

The vehicle information providing unit 1522 acquires the vehicle information of the automobile 150 flowing through the in-vehicle network 154 via the GW device 153. The vehicle information providing unit 1522 provides the vehicle information of the automobile 150 acquired via the GW device 153 to the terminal device 140a through the terminal interface 1521. For example, the vehicle information providing unit 1522 provides the parking state information of the automobile 150 to the terminal device 140a through the terminal interface 1521. As an example of the first embodiment, the vehicle information providing unit 1522 provides the gear information of the automobile 150 serving as the parking state information of the automobile 150 to the terminal device 140a through the terminal interface 1521.

The IVI equipment 152 includes computer hardware such as a CPU and a memory and a function of the IVI equipment 152 is implemented by the CPU executing a computer program stored in the memory.

Next, examples of an information providing method according to the first embodiment will be described.

### Example A-1 of Information Providing Method

Example A-1 of the information providing method according to the first embodiment will be described with reference to FIG. 6. FIG. 6 is a flowchart showing an example of a procedure of the information providing method according to the first embodiment.

The terminal user performs user registration on the information distributing device 130a in advance. The user registering unit 133 of the information distributing device 130a records user registration information of the terminal user acquired through user registration of the terminal user. The user registration information is information including a name, an address, terminal identification information (a terminal ID; for example, a portable phone number or the like) of the terminal device 140a, a vehicle identification number (VIN) of the automobile 150, application identification information (a navigation ID) of the navigation of the IVI equipment 152, and the like. The user registering unit 133 of the information distributing device 130a may accept the user registration through a website.

The communication path 1106 is established between the terminal device 140a of the terminal user and the IVI equipment 152 of the automobile 150. The terminal user may be inside the automobile 150 or may be outside the automobile 150. Also, the terminal user may be the driver of the automobile 150 or may be a fellow passenger who is not the driver.

(Step S11) The vehicle information acquiring unit 142 of the terminal device 140a acquires the gear information of the automobile 150 through the vehicle interface 141. The vehicle information providing unit 1522 of the IVI equipment 152 of the automobile 150 provides the gear information of the automobile 150 to the terminal device 140a through the terminal interface 1521. The parking state information transmitting unit 143 of the terminal device 140a transmits the gear information of the automobile 150 acquired by the vehicle information acquiring unit 142 to the information distributing device 130a via the communication path 1104.

The information distributing device 130a receives the gear information of the automobile 150 from the terminal device 140a via the communication path 1104. In the information distributing device 130a, the parking state information receiving unit 111 of the information provision control unit 110 receives the gear information of the automobile 150 transmitted from the terminal device 140a and received by the information distributing device 130a.

(Step S12) The provision control unit 112 of the information provision control unit 110 determines whether or not the automobile 150 has parked on the basis of the gear information of the automobile 150 received by the parking state information receiving unit 111. The process proceeds to step S13 when it is determined that the automobile 150 has parked and the process proceeds to step S14 when it is determined that the automobile 150 has not parked. Specifically, the process proceeds to step S13 when the gear information of the automobile 150 indicates the “parked” state and the process proceeds to step S14 when the gear information of the automobile 150 does not indicate the “parked” state.

(Step S13) The provision control unit 112 performs control so that the provision information is displayed on the display screen of the terminal device 140a. Specifically, the provision control unit 112 transmits an instruction for transmitting the provision information to the terminal device 140a (a provision information transmission instruction) to the provision information transmitting unit 131 of the information distributing device 130a.

When the provision information transmission instruction is received from the information provision control unit 110 (the provision control unit 112), the provision information transmitting unit 131 acquires the provision information to be transmitted to the terminal device 140a from the provision information acquiring unit 132 and transmits the acquired provision information to the terminal device 140a via the communication path 1104.

When the provision information receiving unit 144 of the terminal device 140a receives the provision information from the information distributing device 130a via the communication path 1104, the provision information receiving unit 144 transmits the received provision information to the display unit. When the display unit 145 receives the provision information from the provision information receiving unit 144, the display unit 145 displays the received provision information. Thereby, the provision information can be presented to the terminal user at a timing when the automobile 150 has parked. The timing at which the automobile 150 has parked is an appropriate timing for presenting the provision information to the terminal user even if the terminal user is the driver of the automobile 150.

(Step S14) The provision control unit 112 determines that the provision information is not to be displayed on the display screen of the terminal device 140a and ends the process of FIG. 6. Therefore, the provision information is not presented to the terminal user at a timing when the automobile 150 has not parked. Thereby, even if the terminal user is the driver of the automobile 150, the provision information is not presented to the terminal user while the terminal user is driving, so that it is possible to prevent the presentation of the provision information from interfering with the driving.

### Example A-2 of Information Providing Method

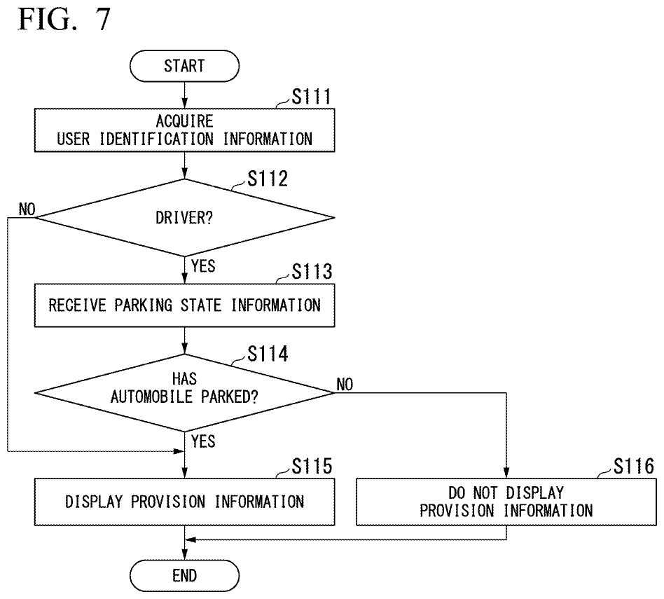

Example A-2 of the information providing method according to the first embodiment will be described with reference to FIG. 7. FIG. 7 is a flowchart showing an example of a procedure of the information providing method according to the first embodiment.

As in the above-described example A-1 of the information providing method, the terminal user performs user registration on the information distributing device 130a in advance. In this user registration, in addition to the user registration information of the above-described example A-1 of the information providing method, registration related to user type information is further performed. In the case of the above-described example 1 of the user type information acquiring method, the terminal user registers whether or not he/she is the driver of the automobile 150. In the case of the above-described example 2 of the user type information acquiring method, the terminal user registers his/her face image. In the case of the above-described example 3 of the user type information acquiring method, the terminal user registers an immobilizer ID of his/her immobilizer. The user registering unit 133 of the information distributing device 130a records the user registration information of the terminal user acquired through the user registration of the terminal user.

The communication path 1106 is established between the terminal device 140a of the terminal user and the IVI equipment 152 of the automobile 150. The terminal user may be inside the automobile 150 or may be outside the automobile 150. Also, the terminal user may be the driver of the automobile 150 or may be a fellow passenger who is not the driver.

(Step S111) In the information distributing device 130a, the user type information acquiring unit 113 of the information provision control unit 110 acquires user type information indicating whether or not the terminal user is the driver of the automobile 150. As the user type information acquiring method, any one of the above-described examples 1, 2, and 3 of the user type information acquiring method is applied.

(Step S112) The provision control unit 112 of the information provision control unit 110 determines whether or not the terminal user is the driver of the automobile 150 on the basis of the user type information acquired by the user type information acquiring unit 113. The process proceeds to step S113 when it is determined that the terminal user is the driver of the automobile 150 and the process proceeds to step S115 when it is determined that the terminal user is not the driver of the automobile 150. Specifically, the process proceeds to step S113 when the user type information indicates that the terminal user is the driver of the automobile 150 and the process proceeds to step S115 when the user type information indicates that the terminal user is not the driver of the automobile 150.

(Step S113) The vehicle information acquiring unit 142 of the terminal device 140a acquires the gear information of the automobile 150 through the vehicle interface 141. The vehicle information providing unit 1522 of the IVI equipment 152 of the automobile 150 provides the gear information of the automobile 150 to the terminal device 140a through the terminal interface 1521. The parking state information transmitting unit 143 of the terminal device 140a transmits the gear information of the automobile 150 acquired by the vehicle information acquiring unit 142 to the information distributing device 130a via the communication path 1104.

The information distributing device 130a receives the gear information of the automobile 150 from the terminal device 140a via the communication path 1104. In the information distributing device 130a, the parking state information receiving unit 111 of the information provision control unit 110 receives the gear information of the automobile 150 transmitted from the terminal device 140a and received by the information distributing device 130a.

(Step S114) The provision control unit 112 of the information provision control unit 110 determines whether or not the automobile 150 has parked on the basis of the gear information of the automobile 150 received by the parking state information receiving unit 111. The process proceeds to step S115 when it is determined that the automobile 150 has parked and the process proceeds to step S116 when it is determined that the automobile 150 has not parked. Specifically, the process proceeds to step S115 when the gear information of the automobile 150 indicates the “parked” state and the process proceeds to step S116 when the gear information of the automobile 150 does not indicate the “parked” state.

(Step S115) The provision control unit 112 performs control so that the provision information is displayed on the display screen of the terminal device 140a. Specifically, the provision control unit 112 transmits an instruction for transmitting the provision information to the terminal device 140a (a provision information transmission instruction) to the provision information transmitting unit 131 of the information distributing device 130a.

When the provision information transmission instruction is received from the information provision control unit 110 (the provision control unit 112), the provision information transmitting unit 131 acquires the provision information to be transmitted to the terminal device 140a from the provision information acquiring unit 132 and transmits the acquired provision information to the terminal device 140a via the communication path 1104.

When the provision information receiving unit 144 of the terminal device 140a receives the provision information from the information distributing device 130a via the communication path 1104, the provision information receiving unit 144 transmits the received provision information to the display unit. When the display unit 145 receives the provision information from the provision information receiving unit 144, the display unit 145 displays the received provision information.

Thereby, when it is determined that the terminal user is the driver of the automobile 150, the provision information can be presented to the terminal user at a timing when the automobile 150 has parked. The timing at which the automobile 150 has parked is an appropriate timing for presenting the provision information to the terminal user who is the driver of the automobile 150.

On the other hand, when it is determined that the terminal user is not the driver of the automobile 150, the provision information can be presented to the terminal user regardless of whether or not the automobile 150 has parked. Thereby, the provision information can be presented to the terminal user who is not the driver of the automobile 150 all the time.

(Step S116) The provision control unit 112 determines that the provision information is not to be displayed on the display screen of the terminal device 140a and ends the process of FIG. 7. Therefore, when it is determined that the terminal user is the driver of the automobile 150, the provision information is not presented to the terminal user at the timing when the automobile 150 has not parked. Thereby, because the provision information is not presented to the terminal user while the terminal user is driving, it is possible to prevent the presentation of the provision information from interfering with the driving.

According to the above-described first embodiment, the information distributing device 130a includes the information provision control unit 110 and the information provision control unit 110 performs control so that provision information is displayed on the display screen of the terminal device 140a when the parking state information of the automobile 150 indicates that the automobile 150 has parked. Thereby, the effect of presenting provision information about coupons and the like to the driver of the automobile 150 at an appropriate timing can be obtained.

### Second Embodiment

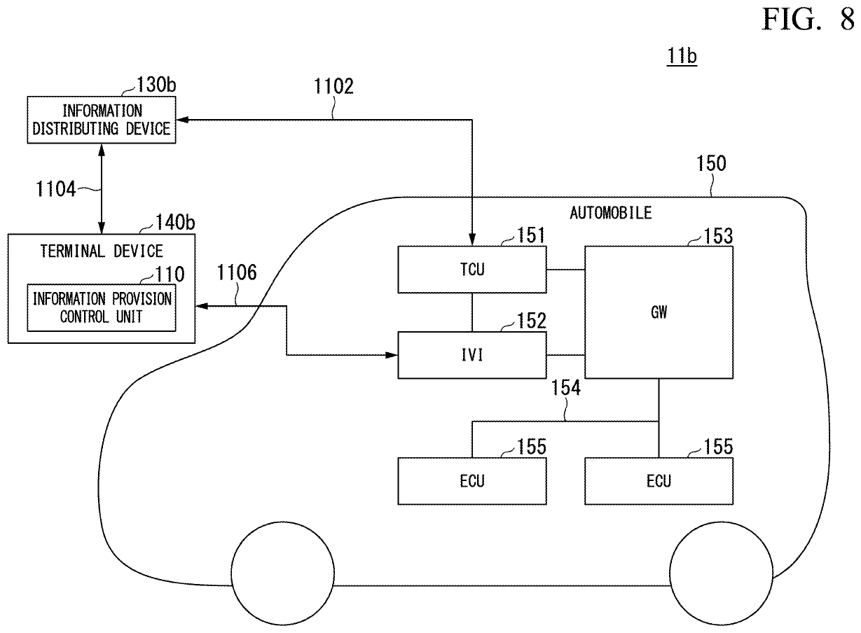

FIG. 8 is a schematic configuration diagram of the information providing system according to a second embodiment. Parts of FIG. 8 corresponding to the parts of FIG. 1 are denoted by the same reference signs and description thereof will be omitted. In FIG. 8, an information providing system 11b includes an information distributing device 130b, a terminal device 140b, and an automobile 150. The terminal device 140b includes an information provision control unit 110. The terminal device 140b may be present inside the automobile 150 or may be present outside the automobile 150.

The information distributing device 130b communicates with the TCU 151 of the automobile 150 via the communication path 1102. The information distributing device 130b communicates with a device mounted in the automobile 150 via the TCU 151 of the automobile 150. The terminal device 140b may be present inside the automobile 150 or may be present outside the automobile 150. The terminal device 140b communicates with the IVI equipment 152 of the automobile 150 via the communication path 1106. The information distributing device 130b and the terminal device 140b communicate with each other via the communication path 1104.

The information distributing device 130b is a device that distributes the provision information to be provided to the user of the terminal device 140b (hereinafter referred to as a terminal user). As an example of the second embodiment, the information distributing device 130b transmits the provision information to the terminal device 140b via the communication path 1104. The provision information is, for example, information of electronic coupons and advertisements with benefits such as discounts that can be used in shops, introductions to service facilities such as gas stations and automobile maintenance shops, route guidance to service facilities, and the like.

In the terminal device 140b, the information provision control unit 110 performs control when the provision information is provided to the terminal user.

A functional configuration of the information provision control unit 110 is the same as that in FIG. 2. A functional configuration of the IVI equipment 152 is the same as that in FIG. 5.

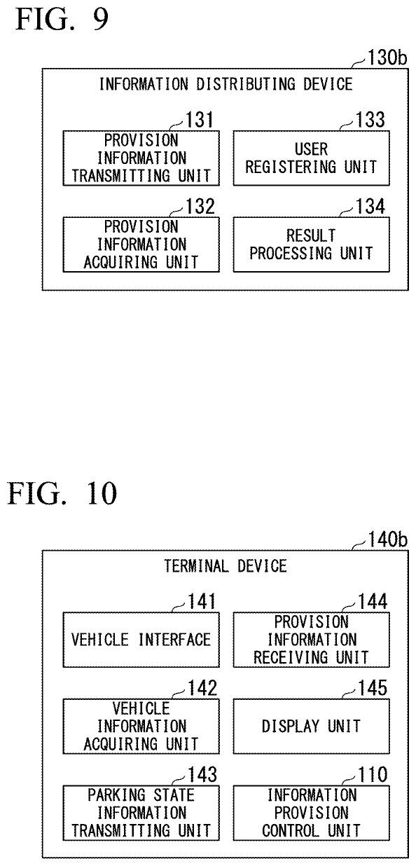

FIG. 9 is a block diagram showing a functional configuration example of the information distributing device according to the second embodiment. Parts of FIG. 9 corresponding to the parts of FIG. 3 are denoted by the same reference signs and description thereof will be omitted. In FIG. 9, the information distributing device 130b includes a provision information transmitting unit 131, a provision information acquiring unit 132, a user registering unit 133, and a result processing unit 134. In the second embodiment, the information distributing device 130b does not include the information provision control unit 110.

FIG. 10 is a block diagram showing a functional configuration example of the terminal device according to the second embodiment. Parts of FIG. 10 corresponding to the parts of FIG. 4 are denoted by the same reference signs and description thereof will be omitted. In FIG. 10, a functional configuration related to information provision of the terminal device 140b is shown. In FIG. 10, the terminal device 140b includes an information provision control unit 110, a vehicle interface 141, a vehicle information acquiring unit 142, a parking state information transmitting unit 143, a provision information receiving unit 144, and a display unit 145.

The information provision control unit 110 is similar to that described above with reference to FIG. 2. Here, as an example of the second embodiment, the provision control unit 112 controls a display timing at which the display unit 145 displays provision information. The display unit 145 displays the provision information on the basis of the control of the display timing by the information provision control unit 110. As an example of the second embodiment, the display unit 145 displays the provision information received by the provision information receiving unit 144 from the information distributing device 130b on the basis of the control of the display timing by the information provision control unit 110. The provision information receiving unit 144 retains the provision information received from the information distributing device 130b in a receiving buffer.

The user type information acquiring unit 113 may acquire the user type information “driver or non-driver” of the terminal user recorded in the information distributing device 130b according to the above-described examples 1, 2, and 3 of the user type information acquiring method. Alternatively, in the above-described examples 1, 2, and 3 of the user type information acquiring method, the terminal user may register the user type information in the terminal device 140b, the terminal device 140b may record the user type information “driver or non-driver” of the terminal user instead of the information distributing device 130b, and the user type information acquiring unit 113 may acquire the user type information “driver or non-driver” of the terminal user recorded in the terminal device 140b.

Next, an example of the information providing method according to the second embodiment will be described. The procedure of the information providing method is similar to the procedure of the first embodiment shown in FIGS. 6 and 7.

### Example B-1 of Information Providing Method

Example B-1 of an information providing method according to the second embodiment will be described with reference to FIG. 6.

The terminal user performs user registration on the information distributing device 130b in advance. The user registering unit 133 of the information distributing device 130b records user registration information of the terminal user acquired through the user registration of the terminal user. The user registration information is information including a name, an address, terminal identification information (a terminal ID; for example, a portable phone number or the like) of the terminal device 140b, a vehicle identification number (VIN) of the automobile 150, navigation application identification information (a navigation ID) of the IVI equipment 152, and the like. The user registering unit 133 of the information distributing device 130b may accept the user registration through a website.

The communication path 1106 is established between the terminal device 140b of the terminal user and the iVI equipment 152 of the automobile 150. The terminal user may be inside the automobile 150 or may be outside the automobile 150. Also, the terminal user may be the driver of the automobile 150 or may be a fellow passenger who is not the driver.

(Step S11) The vehicle information acquiring unit 142 of the terminal device 140b acquires gear information of the automobile 150 through the vehicle interface 141. The vehicle information providing unit 1522 of the IVI equipment 152 of the automobile 150 provides the gear information of the automobile 150 to the terminal device 140b through the terminal interface 1521. In the terminal device 140b, the parking state information transmitting unit 143 transmits the gear information of the automobile 150 acquired by the vehicle information acquiring unit 142 to the information provision control unit 110. The parking state information receiving unit 111 of the information provision control unit 110 receives the gear information of the automobile 150 transmitted from the parking state information transmitting unit 143.

(Step S12) The provision control unit 112 of the information provision control unit 110 determines whether or not the automobile 150 has parked on the basis of the gear information of the automobile 150 received by the parking state information receiving unit 111. The process proceeds to step S13 when it is determined that the automobile 150 has parked and the process proceeds to step S14 when it is determined that the automobile 150 has not parked. Specifically, the process proceeds to step S13 when the gear information of the automobile 150 indicates the “parked” state and the process proceeds to step S14 when the gear information of the automobile 150 does not indicate the “parked” state.

(Step S13) The provision control unit 112 performs control so that the provision information is displayed on the display screen of the terminal device 140b. Specifically, the provision control unit 112 transmits an instruction for displaying the provision information (a provision information display instruction) to the display unit 145. When the provision information display instruction is received from the information provision control unit 110 (the provision control unit 112), the display unit 145 acquires the provision information previously received from the information distributing device 130b and retained by the provision information receiving unit 144 from the provision information receiving unit 144 and displays the acquired provision information.

Thereby, the provision information can be presented to the terminal user at a timing when the automobile 150 has parked. The timing at which the automobile 150 has parked is an appropriate timing for presenting the provision information to the terminal user even if the terminal user is the driver of the automobile 150.

(Step S14) The provision control unit 112 determines that the provision information is not to be displayed on the display screen of the terminal device 140b and ends the process of FIG. 6. Therefore, the provision information is not presented to the terminal user at a timing when the automobile 150 has not parked. Thereby, even if the terminal user is the driver of the automobile 150, the provision information is not presented to the terminal user while the terminal user is driving, so that it is possible to prevent the presentation of the provision information from interfering with the driving.

### Example B-2 of Information Providing Method

Example B-2 of an information providing method according to the second embodiment will be described with reference to FIG. 7.

As in the above-described example B-1 of the information providing method, the terminal user performs user registration on the information distributing device 130b in advance. In this user registration, in addition to the user registration information of the above-described example B-1 of the information providing method, registration related to user type information is further performed. In the case of the above-described example 1 of the user type information acquiring method, the terminal user registers whether or not he/she is the driver of the automobile 150. In the case of the above-described example 2 of the user type information acquiring method, the terminal user registers his/her face image. In the case of the above-described example 3 of the user type information acquiring method, the terminal user registers an immobilizer ID of his/her immobilizer. The user registering unit 133 of the information distributing device 130b records the user registration information of the terminal user acquired through the user registration of the terminal user. Also, the registration information related to the user type information may be recorded in the terminal device 140b.

The communication path 1106 is established between the terminal device 140b of the terminal user and the IVI equipment 152 of the automobile 150. The terminal user may be inside the automobile 150 or may be outside the automobile 150. Also, the terminal user may be the driver of the automobile 150 or may be a fellow passenger who is not the driver.

(Step S111) In the terminal device 140b, the user type information acquiring unit 113 of the information provision control unit 110 acquires user type information indicating whether or not the terminal user is the driver of the automobile 150. As the user type information acquiring method, any one of the above-described examples 1, 2, and 3 of the user type information acquiring method is applied. When the user type information is recorded in the information distributing device 130b, the user type information acquiring unit 113 acquires user type information from the information distributing device 130b via the communication path 1104. When the user type information has been recorded in the terminal device 140b, the user type information acquiring unit 113 acquires the user type information recorded in the terminal device 140b.

(Step S112) The provision control unit 112 of the information provision control unit 110 determines whether or not the terminal user is the driver of the automobile 150 on the basis of the user type information acquired by the user type information acquiring unit 113. The process proceeds to step S113 when it is determined that the terminal user is the driver of the automobile 150 and the process proceeds to step S115 when it is determined that the terminal user is not the driver of the automobile 150. Specifically, the process proceeds to step S113 when the user type information indicates that the terminal user is the driver of the automobile 150 and the process proceeds to step S115 when the user type information indicates that the terminal user is not the driver of the automobile 150.

(Step S113) The vehicle information acquiring unit 142 of the terminal device 140b acquires the gear information of the automobile 150 through the vehicle interface 141. The vehicle information providing unit 1522 of the IVI equipment 152 of the automobile 150 provides the gear information of the automobile 150 to the terminal device 140b through the terminal interface 1521. In the terminal device 140b, the parking state information transmitting unit 143 transmits the gear information of the automobile 150 acquired by the vehicle information acquiring unit 142 to the information provision control unit 110. The parking state information receiving unit 111 of the information provision control unit 110 receives the gear information of the automobile 150 transmitted from the parking state information transmitting unit 143.

(Step S114) The provision control unit 112 of the information provision control unit 110 determines whether or not the automobile 150 has parked on the basis of the gear information of the automobile 150 received by the parking state information receiving unit 111. The process proceeds to step S115 when it is determined that the automobile 150 has parked and the process proceeds to step S116 when it is determined that the automobile 150 has not parked. Specifically, the process proceeds to step S115 when the gear information of the automobile 150 indicates the “parked” state and the process proceeds to step S116 when the gear information of the automobile 150 does not indicate the “parked” state.

(Step S115) The provision control unit 112 performs control so that the provision information is displayed on the display screen of the terminal device 140b. Specifically, the provision control unit 112 transmits an instruction for displaying the provision information (a provision information display instruction) to the display unit 145. When the provision information display instruction is received from the information provision control unit 110 (the provision control unit 112), the display unit 145 acquires the provision information previously received from the information distributing device 130b and retained by the provision information receiving unit 144 from the provision information receiving unit 144 and displays the acquired provision information.

Thereby, when it is determined that the terminal user is the driver of the automobile 150, the provision information can be presented to the terminal user at the timing when the automobile 150 has parked. The timing at which the automobile 150 has parked is an appropriate timing for presenting the provision information to the terminal user who is the driver of the automobile 150.

On the other hand, when it is determined that the terminal user is not the driver of the automobile 150, the provision information can be presented to the terminal user regardless of whether or not the automobile 150 has parked. Thereby, the provision information can be presented to the terminal user who is not the driver of the automobile 150 all the time.

(Step S116) The provision control unit 112 determines that the provision information is not to be displayed on the display screen of the terminal device 140b and ends the process of FIG. 7. Therefore, when it is determined that the terminal user is the driver of the automobile 150, the provision information is not presented to the terminal user at the timing when the automobile 150 has not parked. Thereby, because the provision information is not presented to the terminal user while the terminal user is driving, it is possible to prevent the presentation of the provision information from interfering with the driving.

According to the above-described second embodiment, the terminal device 140b includes the information provision control unit 110 and the information provision control unit 110 performs control so that provision information is displayed on the display screen of the terminal device 140b when the parking state information of the automobile 150 indicates that the automobile 150 has parked. Thereby, it is possible to present provision information about coupons and the like to the driver of the automobile 150 at an appropriate timing.

### Third Embodiment

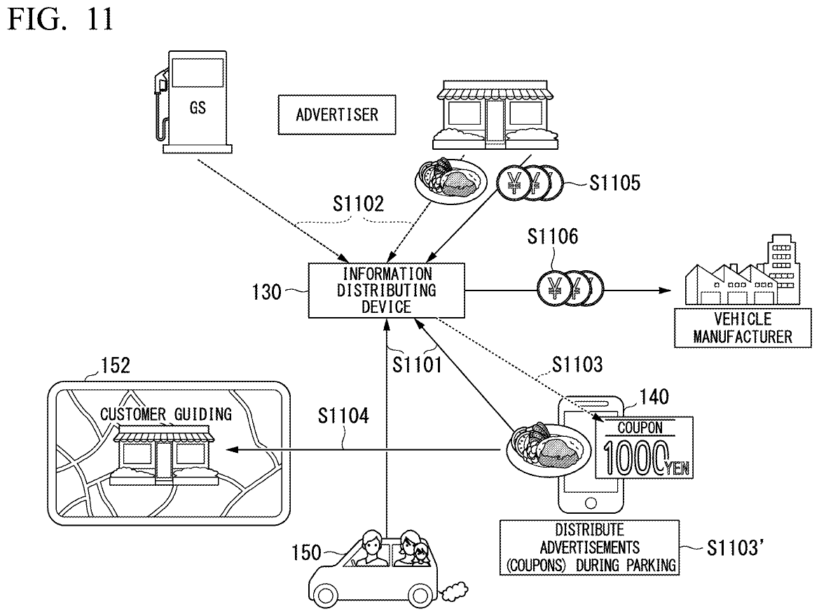

In a third embodiment, a customer guiding business model, which is an application example of the above-described information providing systems 11a and 11b, is implemented. FIG. 11 is an explanatory diagram of an application example of the information providing system according to the third embodiment. In FIG. 11, an information distributing device 130 and a terminal device 140 may be the information distributing device 130a and the terminal device 140a of the information providing system 11a according to the first embodiment or the information distributing device 130b and the terminal device 140b of the information providing system 11b according to the second embodiment.

Hereinafter, an example of the information providing method according to the third embodiment will be described with reference to FIG. 11.

In the third embodiment, the provision information is used to guide customers for advertisers of shops such as restaurants and service facilities such as gas stations. The automobile 150 is a customer guiding tool for use in guiding customers. The terminal user possesses the terminal device 140 and is in the customer guiding tool (the automobile) 150. The terminal user may be the driver of the customer guiding tool (the automobile) 150 or may be a fellow passenger of the customer guiding tool (the automobile) 150 who is not the driver.

(Step S1101) The information distributing device 130 receives preference information indicating preferences of the terminal user from the terminal device 140 of the terminal ID of the terminal user that has been registered as a user. The user registering unit 133 of the information distributing device 130 includes the received preference information in the user registration information of the terminal user and records the user registration information.

The information distributing device 130 receives a travel log of the automobile 150 from the automobile 150 of the VIN of the terminal user who has already registered as the user. The user registering unit 133 of the information distributing device 130 includes the received travel log in the user registration information of the terminal user and records the user registration information.

(Step S1102) The provision information acquiring unit 132 of the information distributing device 130 collects provision information about advertisements, coupons, and the like from the advertiser. The provision information acquiring unit 132 stores the collected provision information.

(Step S1103) The information distributing device 130 distributes the provision information to the terminal device 140 through the provision information transmitting unit 131. Here, the presentation of the provision information to the terminal user is performed in accordance with the control of the information provision control unit 110. In the example of FIG. 11, when the customer guiding tool (the automobile) 150 has parked, the provision information about advertisements, coupons, and the like is distributed to the terminal device 140 (S1103′) and displayed on the terminal device 140.

The provision information about advertisements, coupons, and the like presented to the terminal user by the terminal device 140 generates the customer guiding effect for guiding a person (a customer) who is in the customer guiding tool (the automobile) 150 to the advertiser's shop or service facility.

(Step S1104) The vehicle interface 141 of the terminal device 140 transmits an address of the advertiser's shop or service facility included in the provision information about advertisements, coupons, and the like to the customer guiding tool (the automobile) 150. When the address of the advertiser's shop or service facility is received through the terminal interface 1521, the IVI equipment 152 of the customer guiding tool (the automobile) 150 performs route guidance to the address of the advertiser's shop or service facility according to the navigation function of the IVI equipment 152. Thereby, the customer may visit the advertiser's shop or service facility according to the customer guiding tool (the automobile) 150. Customers can receive benefits such as discounts by presenting advertisements and coupons of the provision information in the advertiser's shop or service facility.

(Step S1105) The advertiser pays a result fee according to a customer guiding record based on the advertisements or the coupons of the provision information to an operator of the information providing system. A notification of payment information of the result fee is provided to the result processing unit 134 of the information distributing device 130.

(Step S1106) The result processing unit 134 executes a process of distributing the result fee indicated by the payment information of the result fee in accordance with a predetermined result processing method. In the example of FIG. 11, the result fee is distributed to a vehicle manufacturer of the automobile 150 which is the customer guiding tool.

### [Provision Information Selecting Method]

Next, a method of selecting provision information to be provided to the terminal user will be described.

The provision information is collected from an advertiser and stored in the information distributing device 130. The information distributing device 130 selects the provision information to be provided to the terminal user from the stored provision information. When the provision information is selected, the vehicle information of the automobile 150 of the VIN of the terminal user that has been registered as a user and the terminal information of the terminal device 140 of the terminal ID of the terminal user that has been registered as a user can be used.

The information distributing device 130 may select the provision information to be provided to the terminal user from the stored provision information on the basis of the vehicle information or the terminal information related to the terminal user or both the vehicle information and the terminal information related to the terminal user. The vehicle information and the terminal information that can be used when the provision information is selected will be described below.

### (Vehicle Information)

An example of vehicle information that can be used when the provision information is selected is shown below.

(1) Vehicle identification number (VIN) of the automobile 150.

(2) Personal information such as a name, an address, and an age collected when the automobile 150 is purchased.

(3) Destination information set in the navigation function of the IVI equipment 152 of the automobile 150. For example, by selecting provision information about advertisements, coupons, and the like for shops suitable for stopping by such as restaurants on a route to a destination using the destination information, the customer guiding effect for the shops can be expected.

(4) Travel log. The travel log includes the following information.

(4-1) Continuous traveling time. For example, by selecting provision information about an introduction to a facility of a rest spot and route guidance thereto with respect to the terminal user of the automobile 150 who has been driving for a long time using the continuous traveling time, the customer guiding effect for the facility of the rest spot can be expected.

(4-2) Driving log. For example, it is possible to estimate a degree of fatigue of the terminal user from driving information such as a location, a vehicle speed, a brake, and a steering angle of the automobile 150 using the driving log. By selecting the provision information about an introduction to a facility of a rest spot, route guidance thereto, and the like in accordance with an estimation result, the customer guiding effect for the facility of the rest spot can be expected.

(5) Log of information acquired from the in-vehicle network 154 such as a CAN. This type of information log includes the following information.

(5-1) Remaining amount of fuel. For example, by selecting the provision information about an introduction to a gas station or route guidance thereto with respect to the terminal user of the automobile 150 having the low remaining amount of fuel using information of the remaining amount of fuel, the customer guiding effect for the gas station can be expected.

(5-2) ECU error message. By selecting provision information about introductions to a regular dealer of the automobile 150 and an automobile maintenance shop, route guidance thereto, and the like on the basis of the error message generated by the ECU 155 of the automobile 150, the customer guiding effect for the regular dealer and the automobile maintenance shop can be expected.

### (Terminal Information)

An example of terminal information that can be used when the provision information is selected is shown below.

(1) Personal information such as a name, an address, and an age collected when the terminal device 140 is purchased.

(2) Terminal ID. Examples of the terminal ID include a portable phone number, an international mobile equipment identity (IMEI), an international mobile subscriber identity (IMSI), and an e-mail address.

(3) Preference information. This preference information includes the following.

(3-1) Usage frequency and usage time of the application of the terminal device 140.

(3-2) Advertisement browsing history showing advertisements browsed through an operation of the terminal user among advertisements presented by the application of the terminal device 140.

(3-3) Action history indicating an action of the terminal user acquired from a movement history of the terminal device 140 such as a location of the terminal device 140.

According to each of the above-described embodiments, it is possible to present provision information about advertisements, coupons, and the like to the driver and fellow passengers of the automobile 150 at an appropriate timing. Thereby, the automobile 150 used by the terminal user on a daily basis can contribute to the implementation of a customer guiding business model used as a customer guiding tool used to guide customers.

### Fourth Embodiment

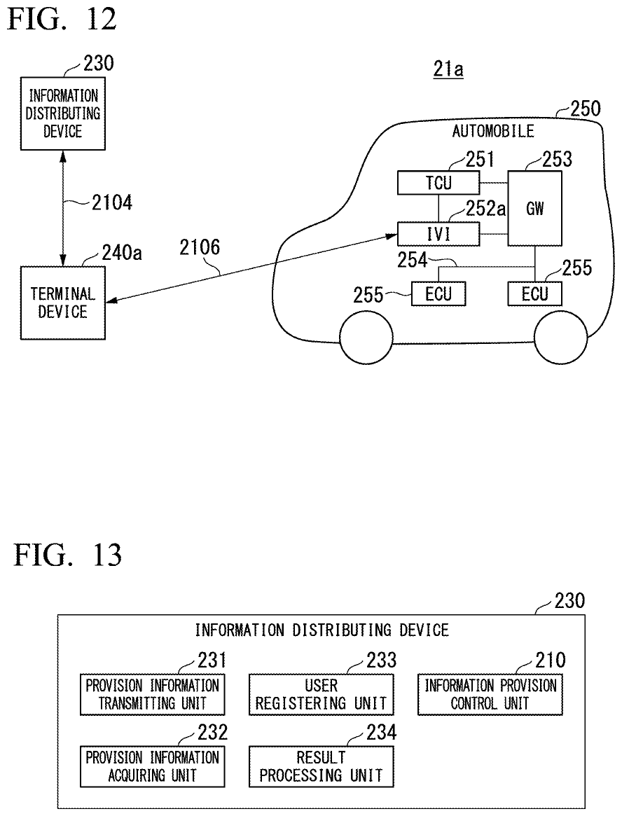

FIG. 12 is a schematic configuration diagram of an information providing system according to a fourth embodiment. In FIG. 12, an information providing system 21a includes an information distributing device 230, a terminal device 240a, and an automobile 250. The terminal device 240a may be present inside the automobile 250 or may be present outside the automobile 250.

The automobile 250 includes a tele communication unit (TCU) 251, in-vehicle infotainment (IVI) equipment 252a, a gateway (GW) device 253, a communication network 254, and a plurality of electronic control units (ECUs) 255. The IVI equipment 252a is an example of an information processing device.

The ECU 255 is an in-vehicle computer provided in the automobile 250. The ECU 255 has a control function such as engine control of the automobile 250. Examples of the ECU 255 include an ECU having an engine control function, an ECU having a transmission control function, an ECU having a steering wheel control function, an ECU having a brake control function, and the like. The GW device 253 has a function of security of data to be applied to the ECU 255 mounted in the automobile 250.

The GW device 253 and the plurality of ECUs 255 are connected to a communication network (hereinafter referred to as an in-vehicle network) 254 provided in the automobile 250. The in-vehicle network 254 may be, for example, a controller area network (CAN). The CAN is known as an example of a communication network mounted in a vehicle. The GW device 253 exchanges data with each ECU 255 via the in-vehicle network 254. The ECU 255 exchanges data with another ECU 255 via the in-vehicle network 254.

Also, the automobile 250 is provided with a communication network other than the CAN as the in-vehicle network 254 and the exchange of data between the GW device 253 and the ECU 255 and the exchange of data between the ECUs 255 via the communication network other than the CAN may be performed. For example, a local interconnect network (LIN) may be provided in the automobile 250. Also, the CAN and the LIN may be provided in the automobile 250.

The TCU 251 is connected to the IVI equipment 252a and the GW device 253. The TCU 251 is a communication device. In the fourth embodiment, the TCU 251 performs communication using a wireless communication network. For example, the TCU 251 may communicate with the information distributing device 230 via the wireless communication network. For example, the TCU 251 may communicate with the terminal device 240a present inside or outside the automobile 250 via the wireless communication network.

The IVI equipment 252a is provided with, for example, a navigation function, a location information service function, a multimedia playback function for music, moving images, and the like, a voice communication function, a data communication function, an Internet connection function, and the like. The IVI equipment 252a includes input devices such as a keyboard, a numeric keypad, and a mouse for inputting data according to a user's operation and a display device such as a liquid crystal display device for displaying data. The IVI equipment 252a may include a touch panel capable of performing both a data input operation and a data display operation.

The IVI equipment 252a is connected to the TCU 251 and the GW device 253. The IVI equipment 252a communicates with the ECU 255 via the GW device 253. Also, the IVI equipment 252a acquires vehicle information of the automobile 250 flowing through the in-vehicle network 254 via the GW device 253.

Also, the IVI equipment 252a has a short-range wireless communication function. For example, short-range wireless communication may be wireless communication of a wireless local area network (LAN) such as “Wi-Fi (registered trademark)” or may be wireless communication of “Bluetooth (registered trademark)” such as BLE. The IVI equipment 252a may communicate with the terminal device 240a through the short-range wireless communication. Also, the IVI equipment 252a may communicate with the terminal device 240a and the information distributing device 230 via the TCU 251.

Also, the IVI equipment 252a includes a terminal interface for cooperating with the terminal device 240a. The terminal interface has a function of displaying a screen generated by the application of the terminal device 240a on the display device of the IVI equipment 252a, a function of transmitting vehicle information of the automobile 250 to the terminal device 240a, and the like. Through the terminal interface, for example, gear information, which is an example of vehicle information of the automobile 250, can be transmitted to the terminal device 240a. The gear information is vehicle information indicating the state of a gear of a transmission of the automobile 250. The terminal device 240a can recognize whether or not the gear of the transmission of the automobile 250 is in a “parked” state according to the gear information received from the automobile 250.

The terminal device 240a may be present inside the automobile 250 or may be present outside the automobile 250. The terminal device 240a communicates with the IVI equipment 252a of the automobile 250 via a communication path 2106. The communication path 2106 may be a communication path for the short-range wireless communication between the terminal device 240a and the IVI equipment 252a. The communication path 2106 may be a communication path via the TCU 251. The communication path 2106 may be, for example, a communication path including the wireless communication network used by the TCU 251 and the Internet. The communication path 2106 may include a communication cable. For example, the terminal device 240a and the IVI equipment 252a may be connected by a communication cable and the terminal device 240a and the IVI equipment 252a may transmit and receive data via the communication cable. For example, the terminal device 240a and the IVI equipment 252a may be connected by a universal serial bus (USB) cable and the terminal device 240a and the IVI equipment 252a may perform USB communication via the USB cable.

The information distributing device 230 and the terminal device 240a communicate with each other via the communication path 2104. The communication path 2104 may be a wireless communication path or a wired communication path or may include a wireless communication path and a wired communication path. The communication path 2104 may be, for example, a communication path including a wireless communication network used by the terminal device 240a and the Internet. The wireless communication network used by the terminal device 240a may be a portable phone network or a wireless LAN.

The information distributing device 230 is a device that distributes provision information. As an example of the fourth embodiment, the information distributing device 230 transmits the provision information to the terminal device 240a via a communication path 2104. The provision information is, for example, information about electronic coupons and advertisements with benefits such as discounts that can be used in shops, introductions to service facilities such as gas stations and automobile maintenance shops, route guidance to service facilities, and the like.

FIG. 13 is a block diagram showing a functional configuration example of the information distributing device according to the fourth embodiment. In FIG. 13, the information distributing device 230 includes an information provision control unit 210, a provision information transmitting unit 231, a provision information acquiring unit 232, a user registering unit 233, and a result processing unit 234.

The information provision control unit 210 controls the distribution of the provision information. The provision information transmitting unit 231 transmits the provision information on the basis of control of a transmission timing by the information provision control unit 210. As an example of the fourth embodiment, the provision information transmitting unit 231 transmits the provision information to the terminal device 240a via the communication path 2104. The provision information acquiring unit 232 acquires the provision information to be distributed and retains the acquired provision information. The user registering unit 233 records user registration information of the user of the terminal device 240a (hereinafter, referred to as a terminal user). The result processing unit 234 executes result processing for processing a result obtained as a result of distributing the provision information to the terminal device 240a.

The information distributing device 230 includes computer hardware such as a central processing unit (CPU) and a memory and a function of the information distributing device 230 is implemented by the CPU executing a computer program stored in the memory. Also, the information distributing device 230 may be configured using a general-purpose computer device or may be configured as a dedicated hardware device.

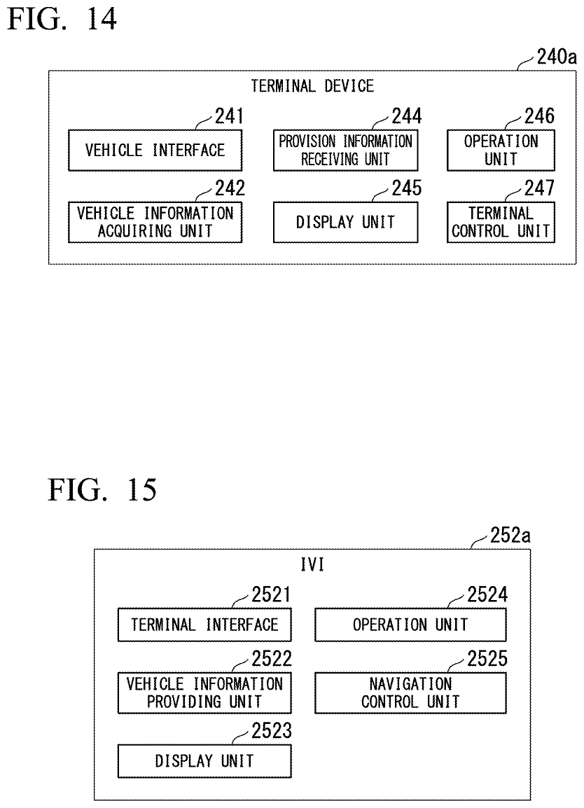

FIG. 14 is a block diagram showing a functional configuration example of the terminal device according to the fourth embodiment. FIG. 14 shows a functional configuration related to information provision of the terminal device 240a. In FIG. 14, the terminal device 240a includes a vehicle interface 241, a vehicle information acquiring unit 242, a provision information receiving unit 244, a display unit 245, an operation unit 246, and a terminal control unit 247.

The vehicle interface 241 cooperates with the terminal interface of the IVI equipment 252a through communication via the communication path 2106. The vehicle interface 241 has a function of transmitting a terminal application screen generated by an application of the terminal device 240a to the IVI equipment 252a and causing the display device of the IVI equipment 252a to display the terminal application screen through the terminal interface of the IVI equipment 252a, a function of receiving the vehicle information of the IVI equipment 252a of the automobile 250 from the terminal interface of the IVI equipment 252a, and the like. The vehicle information acquiring unit 242 acquires the vehicle information of the automobile 250 through the vehicle interface 241.

The provision information receiving unit 244 receives the provision information distributed from the information distributing device 230. As an example of the fourth embodiment, the provision information receiving unit 244 receives the provision information from the information distributing device 230 via the communication path 2104.

The display unit 245 includes a display device for displaying data. The display unit 245 displays the provision information. As an example of the fourth embodiment, the display unit 245 displays the provision information received by the provision information receiving unit 244 from the information distributing device 230. The operation unit 246 includes an input device for inputting data according to the user's operation. The display unit 245 and the operation unit 246 may be touch panels capable of performing both a data input operation and a data display operation.

The terminal control unit 247 controls the terminal device 240a. When the terminal control unit 247 has received a user operation of selecting the provision information distributed from the information distributing device 230 to the terminal device 240a, the terminal control unit 247 transmits navigation information based on the provision information to the automobile 250 through the vehicle interface 241. The navigation information may be information including a destination identified by the location information included in the provision information or may be a navigation screen for the destination.

The terminal device 240a includes computer hardware such as a CPU and a memory and a function of the terminal device 240a is implemented by the CPU executing a computer program stored in the memory. The terminal device 240a may be configured using a general-purpose computer device or may be configured as a dedicated hardware device. Also, as the terminal device 240a, a portable communication terminal device such as a smartphone, or a tablet-type computer device (a tablet PC), or the like may be used.

FIG. 15 is a block diagram showing a functional configuration example of the IVI equipment according to the fourth embodiment. FIG. 15 shows a functional configuration related to information provision of the IVI equipment 252a. In FIG. 15, the IVI equipment 252a includes a terminal interface 2521, a vehicle information providing unit 2522, a display unit 2523, an operation unit 2524, and a navigation control unit 2525.

The terminal interface 2521 cooperates with the vehicle interface 241 of the terminal device 240a through communication via the communication path 2106. The terminal interface 2521 has a function of receiving the terminal application screen generated by the application of the terminal device 240a from the vehicle interface 241 and displaying the received terminal application screen on the display unit 2523, a function of transmitting the vehicle information of the automobile 250 to the vehicle interface 241, and the like.

The vehicle information providing unit 2522 acquires vehicle information of the automobile 250 flowing through the in-vehicle network 254 via the GW device 253. The vehicle information providing unit 2522 provides the vehicle information of the automobile 250 acquired via the GW device 253 to the terminal device 240a through the terminal interface 2521.

The display unit 2523 includes a display device for displaying data. The operation unit 2524 includes an input device for inputting data according to the user's operation. The display unit 2523 and the operation unit 2524 may be touch panels capable of performing both a data input operation and a data display operation.

The navigation control unit 2525 controls the navigation function of the IVI equipment 252a. The navigation control unit 2525 executes navigation on the basis of the navigation information received from the terminal device 240a through the terminal interface 2521. When the navigation information received from the terminal device 240a is destination information indicating a destination, the navigation control unit 2525 executes the navigation to the destination indicated by the destination information. When the navigation information received from the terminal device 240a is a navigation screen to the destination, the navigation control unit 2525 executes navigation to the destination using the navigation screen.

The IVI equipment 252a includes computer hardware such as a CPU and a memory and a function of the IVI equipment 252a is implemented by the CPU executing a computer program stored in the memory.

Next, an example of the navigation method according to the fourth embodiment will be described.

### Example A-1 of Navigation Method

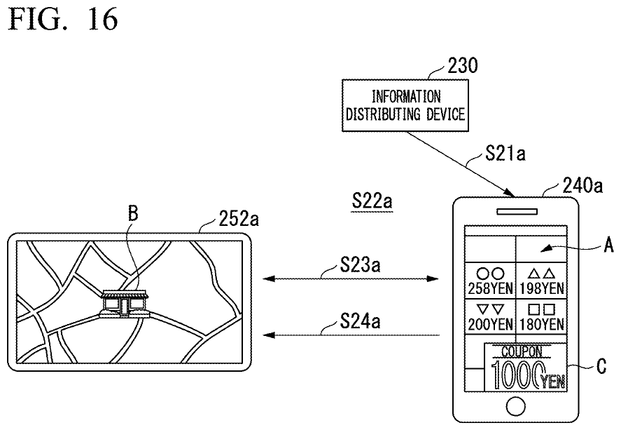

Example A-1 of the navigation method according to the fourth embodiment will be described with reference to FIG. 16. FIG. 16 is a flowchart showing example A-1 of a procedure of the navigation method according to the fourth embodiment.

The terminal user performs user registration on the information distributing device 230 in advance. The user registering unit 233 of the information distributing device 230 records user registration information of the terminal user acquired through the user registration of the terminal user. The user registration information is information including a name, an address, terminal identification information (a terminal ID; for example, a portable phone number or the like) of the terminal device 240a, a vehicle identification number (VIN) of the automobile 250, navigation application identification information (a navigation ID) of the IVI equipment 252a, and the like. The user registering unit 233 of the information distributing device 230 may accept the user registration through a website.

(Step S21a) The information distributing device 230 transmits the provision information to the terminal device 240a via the communication path 2104. The provision information is information including location information indicating a destination for guiding customers. The location information is, for example, an address or “latitude and longitude” of the destination. The provision information is, for example, information that is an advertisement for a shop and includes location information of the shop. Also, the provision information may be information including an electronic coupon with benefits such as discounts that can be used in the shop. In the example of FIG. 16, provision information A is an advertisement of shop B and is information including location information of shop B and electronic coupon C with the benefit of a discount of 1,000 yen that can be used in shop B. The terminal device 240a stores provision information A received from the information distributing device 230 in the memory.

(Step S22a) The terminal control unit 247 of the terminal device 240a displays provision information A on the display unit 245 and prompts the user to select provision information A. For example, the terminal control unit 247 displays provision information A on the display unit 245, and also displays a message “Would you like to go here?” and selection buttons “Yes” and “No.” The terminal user performs an operation of selecting the selection button “Yes” or “No.” When the terminal control unit 247 has received the user operation in which the selection button “Yes” is selected, the terminal control unit 247 proceeds to step S23a. On the other hand, when the terminal control unit 247 has received the user operation in which the selection button “No” is selected, the terminal control unit 247 ends the process of FIG. 16.

(Step S23a) The terminal control unit 247 of the terminal device 240a causes a communication path 2106 to be established between the terminal device 240a and the WI equipment 252a of the automobile 250. Also, the communication path 2106 between the terminal device 240a and the IVI equipment 252a of the automobile 250 may be established in advance. When the conmunication path 2106 is established in advance, step S23a is omitted and the process proceeds to step S24a.

(Step S24a) The terminal control unit 247 of the terminal device 240a transmits navigation information based on provision information A to the automobile 250 through the vehicle interface 241. The navigation control unit 2525 of the IVI equipment 252a of the automobile 250 executes navigation on the basis of the navigation information received from the terminal device 240a through the terminal interface 2521. Thereby, in the IVI equipment 252a of the automobile 250, the navigation to shop B related to provision information A can be automatically executed.

### Example 1 of Navigation

When the navigation information is location information of shop B included in provision information A, the navigation control unit 2525 sets the location of shop B indicated by the location information of shop B as the destination and executes navigation to the location of shop B (the destination).

### Example 2 of Navigation

When the navigation information is a navigation screen with the location of shop B indicated by the location information of shop B included in provision information A as the destination, the navigation control unit 2525 displays the navigation screen on the display unit 2523 and executes navigation to the destination according to the navigation screen.

Also, the provision information may be provided in the form of an information magazine (hereinafter referred to as a provision information magazine) including information about a plurality of recommended spots such as shops and facilities recommended to the terminal user. The terminal user browses the provision information magazine through the terminal device 240a and performs a click operation of selecting a desired recommended spot from the provision information magazine. When the click operation is received, the terminal control unit 247 transmits the navigation information of the recommended spot selected by the click operation to the automobile 250 through the vehicle interface 241.

Alternatively, when a click operation of selecting a desired recommended spot from the provision information magazine is received, the terminal control unit 247 displays a map screen showing the recommended spot selected by the click operation on the display unit 245 and displays a message “Would you like to go here?” and the selection buttons “Yes” and “No” on the display unit 245. When a user operation in which the selection button “Yes” is selected has been received, the terminal control unit 247 transmits navigation information of the recommended spot selected by the click operation to the automobile 250 through the vehicle interface 241. On the other hand, when a user operation in which the selection button “No” is selected has been received, the terminal control unit 247 does not transmit the navigation information of the recommended spot selected by the click operation to the automobile 250.

According to the provision information magazine described above, the user can easily browse the desired recommended spot from a plurality of recommended spots and set the desired recommended spot as the destination. Thereby, the effect of improving a rate at which customers are guided to the recommended spot can be obtained.

### Example A-2 of Navigation Method

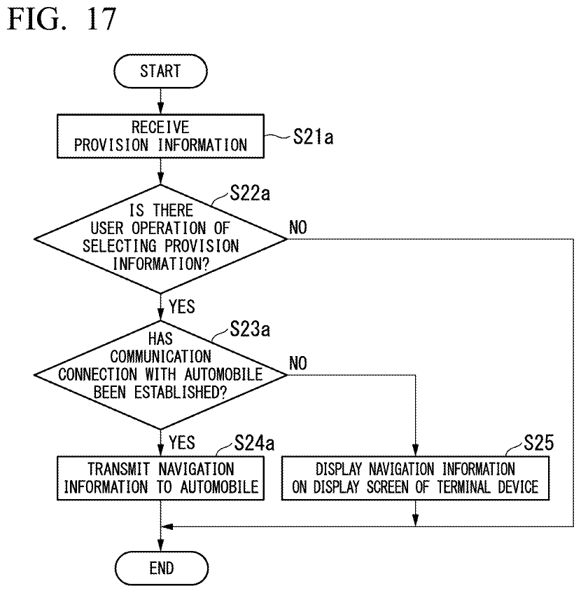

Example A-2 of the navigation method according to the fourth embodiment will be described with reference to FIG. 17. FIG. 17 is a flowchart showing example A-2 of a procedure of the navigation method according to the fourth embodiment.

As in the above-described example A-1 of the information providing method, the terminal user performs user registration on the information distributing device 230 in advance. Step S21a and step S22a are the same as those of the above-described example A-1 of the information providing method. When the user operation of selecting provision information A has been received, the process proceeds to step S23a.

(Step S23a) The terminal control unit 247 of the terminal device 240a causes the communication path 2106 to be established between the terminal device 240a and the iVI equipment 252a of the automobile 250. Next, the terminal control unit 247 determines whether or not the communication path 2106 has been established. When the communication path 2106 has been established (the terminal device 240a has established a communication connection with the automobile 250), the process proceeds to step S24a. On the other hand, when the communication path 2106 has not been established (the terminal device 240a has not established the communication connection with the automobile 250), the process proceeds to step S25. Also, the communication path 2106 between the terminal device 240a and the IVI equipment 252a of the automobile 250 may be established in advance. When the communication path 2106 has been established in advance, the process proceeds to step S24a.

Step S24a is the same as that of the above-described example A-1 of the information providing method.

(Step S25) The terminal control unit 247 causes the display unit 245 to display navigation information based on provision information A. For example, the terminal control unit 247 executes navigation of a route using public transportation such as a railroad or a bus with the location of shop B indicated by the location information of shop B included in provision information A as the destination. According to the navigation of the route using public transportation, because the terminal device 240a has not established a communication connection with the automobile 250, the terminal user is likely to use the public transportation without using the automobile 250, so that the effect of providing the convenience of use for the terminal user can be obtained.

Also, the terminal control unit 247 may display a navigation selection screen for selecting either the navigation of the route using the automobile 250 or the navigation of the route using public transportation and execute the selected navigation.

According to the fourth embodiment described above, when a user operation of selecting the provision information distributed from the information distributing device 230 to the terminal device 240a has been received, the terminal device 240a transmits navigation information based on the provision information to the automobile 250 through the vehicle interface 241. Thereby, because navigation can be automatically executed according to the navigation information based on the provision information in the automobile 250, the effect of contributing to guiding customers according to the provision information can be obtained.

Also, when a communication connection with the automobile 250 through the vehicle interface 241 has not been established, the terminal device 240a causes the navigation information to be displayed on the display screen of the terminal device 240a. Thereby, it is possible to selectively execute an operation of performing the navigation of a route using the automobile 250 through the IVI equipment 252a of the automobile 250 when a communication connection between the terminal device 240a and the automobile 250 has been established and an operation of performing the navigation of a route using public transportation through the terminal device 240a when a communication connection between the terminal device 240a and the automobile 250 has not been established.

For example, before the terminal user gets into the automobile 250, the terminal device 240a and the automobile 250 do not establish a communication connection and the terminal device 240a performs navigation of the route using public transportation on the basis of the provision information. Subsequently, when the terminal user gets into the automobile 250, the communication connection between the terminal device 240a and the automobile 250 is established and the IVI equipment 252a performs navigation of the route using the automobile 250 on the basis of the provision information. Thereby, it is possible to automatically perform switching from the navigation of the route using public transportation before the terminal user gets into the automobile 250 to the navigation of the route using the automobile 250 after the terminal user gets into the automobile 250.

### Fifth Embodiment

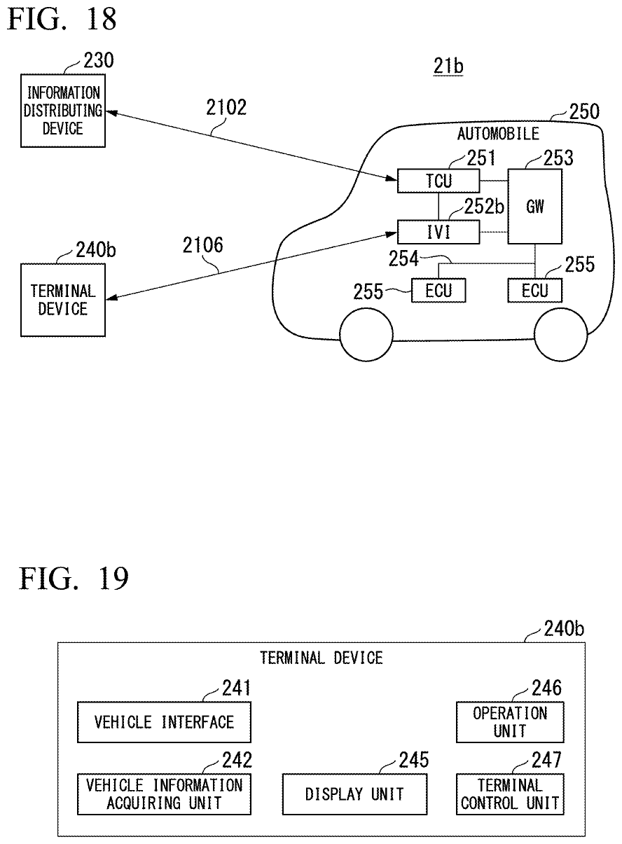

FIG. 18 is a schematic configuration diagram of an information providing system according to a fifth embodiment. Parts of FIG. 18 corresponding to the parts of FIG. 12 are denoted by the same reference signs and description thereof will be omitted. In FIG. 18, an information providing system 21b includes an information distributing device 230, a terminal device 240b, and an automobile 250. In the automobile 250, a difference from the configuration shown in FIG. 12 described above is only IVI equipment 252b. The IVI equipment 252b is an example of an information processing device. The terminal device 240b may be present inside the automobile 250 or may be outside the automobile 250.

The information distributing device 230 communicates with a TCU 251 of the automobile 250 via a communication path 2102. The information distributing device 230 communicates with an exemplary device mounted in the automobile 250 via the TCU 251 of the automobile 250. The information distributing device 230 communicates with the IVI equipment 252b mounted in the automobile 250 via the TCU 251 of the automobile 250. The communication path 2102 is a communication path including a wireless communication path of a wireless communication network used by the TCU 251. The communication path 2102 may include a wireless communication path and a wired communication path. The communication path 2102 may be, for example, a communication path including the wireless communication network used by the TCU 251 and the Internet.

The information distributing device 230 is a device that distributes provision information. As an example of the fifth embodiment, the information distributing device 230 transmits the provision information to the automobile 250 via the communication path 2102. The provision information is similar to that of the fourth embodiment described above.

FIG. 19 is a block diagram showing a functional configuration example of a terminal device according to the fifth embodiment. Parts of FIG. 19 corresponding to the parts of FIG. 14 are denoted by the same reference signs and description thereof will be omitted. In FIG. 19, a functional configuration related to information provision of the terminal device 240b is shown. In FIG. 19, the terminal device 240b includes a vehicle interface 241, a vehicle information acquiring unit 242, a display unit 245, an operation unit 246, and a terminal control unit 247. In the fifth embodiment, the terminal device 240b does not include a provision information receiving unit 244.

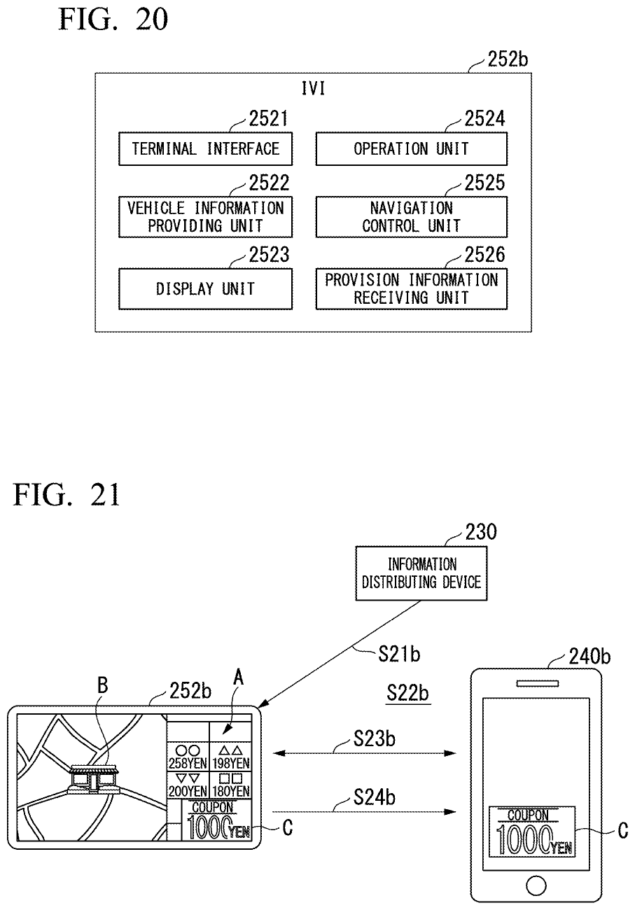

FIG. 20 is a block diagram showing a functional configuration example of the IVI equipment according to the fifth embodiment. Parts of FIG. 20 corresponding to the parts of FIG. 15 are denoted by the same reference signs and description thereof will be omitted. A functional configuration related to information provision of the IVI equipment 252b is shown in FIG. 20. In FIG. 20, the WI equipment 252b includes a terminal interface 2521, a vehicle information providing unit 2522, a display unit 2523, an operation unit 2524, a navigation control unit 2525, and a provision information receiving unit 2526.

The provision information receiving unit 2526 receives the provision information distributed from the information distributing device 230. As an example of the fifth embodiment, the provision information receiving unit 2526 receives the provision information from the information distributing device 230 via the communication path 2102.

When a user operation of selecting the provision information distributed from the information distributing device 230 to the IVI equipment 252b has been received, the navigation control unit 2525 causes the navigation information based on the provision information to be displayed on the display screen of the display unit 2523 of the IVI equipment 252b. The navigation control unit 2525 executes navigation to the destination identified by the location information included in the provision information. Also, the navigation control unit 2525 may transmit the provision information to the terminal device 240b via the terminal interface 2521 at a timing when the automobile 250 arrives at the destination.

Next, an example of the navigation method according to the fifth embodiment will be described.

### <Example of Navigation Method>

An example of the navigation method according to the fifth embodiment will be described with reference to FIG. 21. FIG. 21 is a flowchart showing an example of a procedure of the navigation method according to the fifth embodiment.

A user of the terminal device 240b (hereinafter referred to as a terminal user) performs user registration on the information distributing device 230 in advance. The user registering unit 233 of the information distributing device 230 records user registration information of the terminal user acquired through the user registration of the terminal user. The user registration information is information including a name, an address, terminal identification information (a terminal ID; for example, a portable phone number or the like) of the terminal device 240b, a vehicle identification number (VIN) of the automobile 250, application identification information (a navigation ID) of the navigation of the IVI equipment 252b, and the like. The user registering unit 233 of the information distributing device 230 may accept the user registration through a website.

(Step S21b) The information distributing device 230 transmits the provision information to the automobile 250 via the communication path 2102. The provision information is information including location information indicating a destination for guiding customers as in the above-described fourth embodiment. In the example of FIG. 21, provision information A is an advertisement of shop B and is information including the location information of shop B and electronic coupon C with the benefit of a discount of 1,000 yen that can be used in shop B. The IVI equipment 252b of the automobile 250 stores provision information A received from the information distributing device 230 in the memory.

(Step S22b) The navigation control unit 2525 of the IVI equipment 252b of the automobile 250 displays provision information A on the display unit 2523 and prompts the user to select provision information A. For example, the navigation control unit 2525 displays provision information A on the display unit 2523 and displays a message “Would you like to go here?” and selection buttons “Yes” and “No.” The terminal user performs an operation of selecting the selection button “Yes” or “No.” When a user operation in which the selection button “Yes” is selected has been received, the navigation control unit 2525 proceeds to step S23b. On the other hand, when a user operation in which the selection button “No” is selected has been received, the navigation control unit 2525 ends the process of FIG. 21.

(Step S23b) The navigation control unit 2525 establishes a communication path 2106 between the IVI equipment 252b and the terminal device 240b. The communication path 2106 between the IVI equipment 252b and the terminal device 240b may be established in advance. When the communication path 2106 has been established in advance, step S23b is omitted and the process proceeds to step S24b.

(Step S24b) The navigation control unit 2525 causes navigation information based on provision information A to be displayed on the display screen of the display unit 2523 of the IVI equipment 252b. The navigation control unit 2525 sets the location of shop B indicated by the location information of shop B included in provision information A as the destination and executes navigation to the location (the destination) of shop B. Thereby, the IVI equipment 252b of the automobile 250 can automatically execute the navigation to shop B related to provision information A.

Next, the navigation control unit 2525 transmits provision information A to the terminal device 240b at a timing when the automobile 250 arrives at the location (the destination) of shop B. As an example of the fifth embodiment, electronic coupon C included in provision information A is transmitted to the terminal device 240b. The terminal device 240b stores electronic coupon C received from the automobile 250 in the memory. The terminal control unit 247 of the terminal device 240b displays electronic coupon C on the display unit 245. Thereby, the terminal user can receive the benefit of a discount of 1,000 yen by presenting electronic coupon C in shop B where he/she has arrived through navigation. Also, the communication path for transmitting provision information A (for example, electronic coupon C) from the automobile 250 to the terminal device 240b may be a direct communication path established with the terminal device 240b through the terminal interface 2521 or may be a communication path via the Internet using an e-mail or the like.

Also, the provision information may be a provision information magazine including information about a plurality of recommended spots such as shops and facilities recommended to the terminal user as in the fourth embodiment described above. The terminal user performs a click operation of browsing the provision information magazine and selecting a desired recommended spot from the provision information magazine using the WI equipment 252b. When the click operation is received, the navigation control unit 2525 causes the navigation information of the recommended spot selected by the click operation to be displayed on the display screen of the display unit 2523.

Alternatively, when a click operation of selecting a desired recommended spot from the provision information magazine is received, the navigation control unit 2525 displays a map screen showing the recommended spot selected by the click operation on the display unit 2523 and displays a message “Would you like to go here?” and the selection buttons “Yes” and “No” on the display unit 2523. When the user operation in which the selection button “Yes” is selected has been received, the navigation control unit 2525 causes the navigation information of the recommended spot selected by the click operation to be displayed on the display screen of the display unit 2523. On the other hand, when the user operation in which the selection button “No” is selected has been received, the navigation control unit 2525 does not cause the navigation information of the recommended spot selected by the click operation to be displayed on the display screen of the display unit 2523.

According to the provision information magazine described above, the user can easily browse the desired recommended spot from a plurality of recommended spots and set the desired recommended spot as the destination. Thereby, the effect of improving a rate at which customers are guided to the recommended spot can be obtained.

Also, the navigation control unit 2525 may display the provision information on the display unit 2523 only when the gear of the transmission of the automobile 250 is in the “parked” state on the basis of the gear information which is an example of the vehicle information of the automobile 250. Thereby, because the provision information is not presented while the driver of the automobile 250 is driving, it is possible to prevent the presentation of the provision information from interfering with the driving.

According to the above-described fifth embodiment, when a user operation of selecting the provision information distributed from the information distributing device 230 to the IVI equipment 252b has been received, the IVI equipment 252b of the automobile 250 displays the navigation information based on the provision information on the display screen of the IVI equipment 252b and executes navigation to the destination identified by the location information included in the provision information. Thereby, because navigation can be automatically executed according to the navigation information based on the provision information in the automobile 250, the effect of contributing to guiding customers according to the provision information can be obtained.

Also, the IVI equipment 252b transmits the provision information (for example, electronic coupon C) to the terminal device 240b at a timing when the automobile 250 arrives at a destination (shop B) based on provision information A.

Thereby, the terminal user can receive the benefit of a discount of 1,000 yen by presenting electronic coupon C in shop B where he/she has arrived through navigation. Thus, the customer guiding effect can be increased by performing the navigation and the transmission of the provision information (for example, electronic coupon C) to the terminal device 240b in cooperation.

### Sixth Embodiment

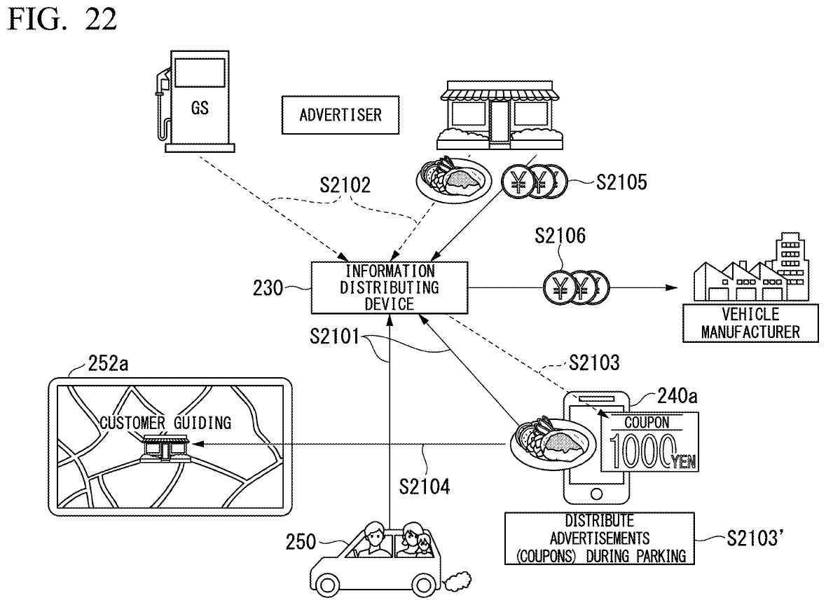

In a sixth embodiment, a customer guiding business model, which is an application example of the above-described information providing systems 21a and 21b, is implemented. FIG. 22 is an explanatory diagram of an application example of the information providing system according to the sixth embodiment. In the application example of FIG. 22, the above-described information providing system 21a is applied. The same can be applied to the above-described information providing system 21b.

Hereinafter, an example of the information providing method according to the sixth embodiment will be described with reference to FIG. 22.

in the sixth embodiment, provision information is used to guide customers for advertisers of shops such as restaurants and service facilities such as gas stations. An automobile 250 is a customer guiding tool for use in guiding customers. A user of the terminal device 240a (hereinafter referred to as a terminal user) possesses the terminal device 240a and is in the customer guiding tool (the automobile) 250. The terminal user may be a driver of the customer guiding tool (the automobile) 250 or may be a fellow passenger of the customer guiding tool (the automobile) 250 who is not the driver.

(Step S2101) The information distributing device 230 receives preference information indicating preferences of the terminal user from the terminal device 240a of a terminal ID of the terminal user that has been registered as a user. The user registering unit 233 of the information distributing device 230 includes the received preference information in user registration information of the terminal user and records the user registration information.

The information distributing device 230 receives a travel log of the automobile 250 from the automobile 250 of a VIN of the terminal user who has been already registered. The user registering unit 233 of the information distributing device 230 includes the received travel log in the user registration information of the terminal user and records the user registration information.

(Step S2102) The provision information acquiring unit 232 of the information distributing device 230 collects provision information about advertisements, coupons, and the like from the advertiser. The provision information acquiring unit 232 stores the collected provision information.

(Step S2103) The information distributing device 230 distributes the provision information to the terminal device 240a through the provision information transmitting unit 231. Here, the presentation of the provision information to the terminal user is performed according to control of the information provision control unit 210. In the example of FIG. 22, when the customer guiding tool (the automobile) 250 has parked, the provision information about advertisements, coupons, and the like is distributed to the terminal device 240a (S2103′) and displayed on the terminal device 240a. Provision information about advertisements, coupons, and the like presented to the terminal user by the terminal device 240a generates the customer guiding effect for guiding a person (a customer) who is in the customer guiding tool (the automobile) 250 to the advertiser's shop or service facility.

(Step S2104) The vehicle interface 241 of the terminal device 240a transmits an address of the advertiser's shop or service facility included in the provision information about advertisements, coupons, and the like to the customer guiding tool (the automobile) 250. When the address of the advertiser's shop or service facility is received through the terminal interface 2521, the IVI equipment 252a of the customer guiding tool (the automobile) 250 performs route guidance to the address of the advertiser's shop or service facility according to the navigation function of the IVI equipment 252a. Thereby, the customer visits the advertiser's shop or service facility according to the customer guiding tool (the automobile) 250. Customers can receive benefits such as discounts by presenting advertisements and coupons for provision information in the advertiser's shop or service facility.

(Step S2105) The advertiser pays a result fee to an operator of the information providing system according to a customer guiding record based on the advertisements and the coupons of the provision information. A notification of payment information of the result fee is provided to the result processing unit 234 of the information distributing device 230.

(Step S2106) The result processing unit 234 executes a process of distributing the result fee indicated by the payment information of the result fee according to a predetermined result processing method. In the example of FIG. 22, the result fee is distributed to a vehicle manufacturer of the automobile 250 which is a customer guiding tool.

### [Provision Information Selecting Method]

Next, a method of selecting the provision information to be provided to the terminal user will be described. In the description here, a terminal device 240 and IVI equipment 252 may be the terminal device 240a and the IVI equipment 252a of the information providing system 21a according to the fourth embodiment or the terminal device 240b and the IVI equipment 252b of the information providing system 21b according to the fifth embodiment.

The provision information is collected from an advertiser and stored in the information distributing device 230. The information distributing device 230 selects the provision information to be provided to the terminal user from the stored provision information. When the provision information is selected, the vehicle information of the automobile 250 of the VIN of the terminal user that has been registered as a user and the terminal information of the terminal device 240 of the terminal ID of the terminal user that has been registered as a user can be used.

The information distributing device 230 may select the provision information to be provided to the terminal user from the stored provision information on the basis of the vehicle information or the terminal information related to the terminal user or both the vehicle information and the terminal information related to the terminal user. The vehicle information and the terminal information that can be used when the provision information is selected will be described below.

### (Vehicle Information)

An example of vehicle information that can be used when the provision information is selected is shown below.

(1) Vehicle identification number (VIN) of the automobile 250.

(2) Personal information such as a name, an address, and an age collected when the automobile 250 is purchased.

(3) Destination information set in the navigation function of the IVI equipment 252 of the automobile 250. For example, by selecting provision information about advertisements, coupons, and the like for shops suitable for stopping by such as restaurants on a route to a destination using the destination information, the customer guiding effect for the shops can be expected.

(4) Travel log. The travel log includes the following information.

(4-1) Continuous traveling time. For example, by selecting provision information about an introduction to a facility of a rest spot and route guidance thereto with respect to the terminal user of the automobile 250 who has been driving for a long time using the continuous traveling time, the customer guiding effect for the facility of the rest spot can be expected.

(4-2) Driving log. For example, it is possible to estimate a degree of fatigue of the terminal user from driving information such as a location, a vehicle speed, a brake, and a steering angle of the automobile 250 using the driving log. By selecting the provision information about an introduction to a facility of a rest spot, route guidance thereto, and the like in accordance with an estimation result, the customer guiding effect for the facility of the rest spot can be expected.

(5) Log of information acquired from the in-vehicle network 254 such as a CAN. This type of information log includes the following information.

(5-1) Remaining amount of fuel. For example, by selecting the provision information about an introduction to a gas station or route guidance thereto with respect to the terminal user of the automobile 250 having the low remaining amount of fuel using information of the remaining amount of fuel, the customer guiding effect for the gas station can be expected.

(5-2) ECU error message. By selecting provision information about introductions to a regular dealer of the automobile 250 and an automobile maintenance shop, route guidance thereto, and the like on the basis of the error message generated by the ECU 255 of the automobile 250, the customer guiding effect for the regular dealer and the automobile maintenance shop can be expected.

### (Terminal Information)

An example of terminal information that can be used when the provision information is selected is shown below.

(1) Personal information such as a name, an address, and an age collected when the terminal device 240 is purchased.

(2) Terminal ID. Examples of the terminal ID include a portable phone number, an international mobile equipment identity (IMEI), an international mobile subscriber identity (IMSI), and an e-mail address.

(3) Preference information. This preference information includes the following.

(3-1) Usage frequency and usage time of the application of the terminal device 240.

(3-2) Advertisement browsing history showing advertisements browsed through an operation of the terminal user among advertisements presented by the application of the terminal device 240.

(3-3) Action history indicating an action of the terminal user acquired from a movement history of the terminal device 240 such as a location of the terminal device 240.

According to each of the above-described embodiments, navigation based on the provision information can be automatically executed in the IVI equipment 252 of the automobile 250. Thereby, the effect of contributing to guiding customers through the provision information can be obtained. Also, the automobile 250 can guide customers to a distant shop or the like where they cannot arrive on foot normally by executing the navigation of the automobile 250.

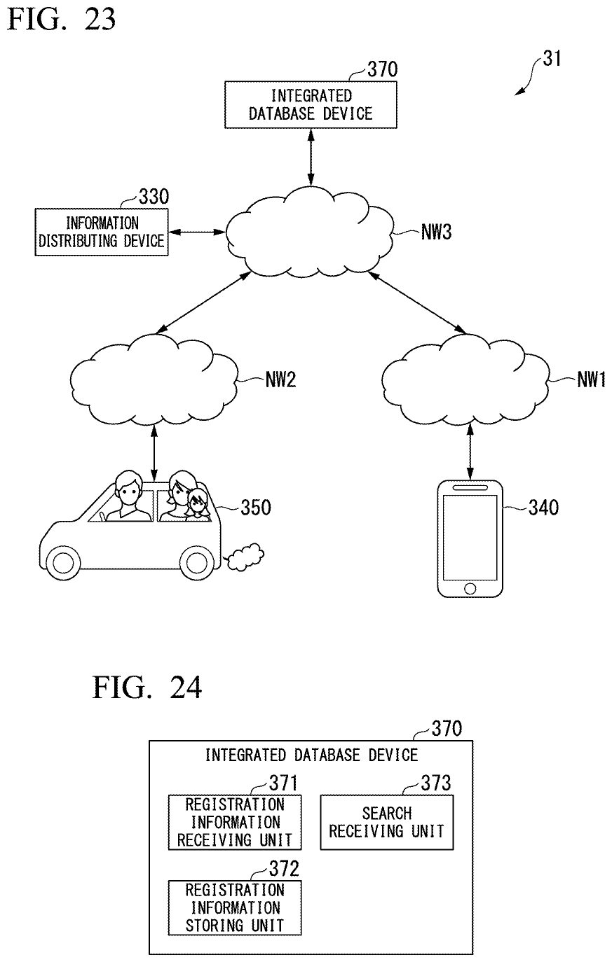

FIG. 23 is a schematic configuration diagram of an information providing system according to a seventh embodiment. In FIG. 23, an information providing system 31 includes an information distributing device 330 and an integrated database device 370. The information distributing device 330 and the integrated database device 370 communicate with each other via a communication network NW3. The communication network NW3 is, for example, the Internet.

A terminal device 340 performs communication via a communication network NW1. The communication network NW1 is, for example, a wireless communication network such as a portable phone network or a wireless local area network (LAN). The communication network NW1 may be a wired communication network.

The terminal device 340 communicates with the information distributing device 330 and the integrated database device 370 via the communication network NW1 and the communication network NW3.

An automobile 350 performs communication via a communication network NW2. The communication network NW2 is a wireless communication network such as a portable phone network or a wireless LAN. The automobile 350 communicates with the information distributing device 330 and the integrated database device 370 via the communication network NW2 and the communication network NW3.

The communication network NW1 and the communication network NW2 may be the same communication network or different communication networks.

The terminal device 340 may be present inside the automobile 350 or may be present outside the automobile 350.

FIG. 24 is a block diagram showing a functional configuration example of the integrated database device according to the seventh embodiment. In FIG. 24, the integrated database device 370 includes a registration information receiving unit 371, a registration information storing unit 372, and a search receiving unit 373.

The registration information receiving unit 371 receives terminal information registration information and vehicle information registration information. The terminal information registration information is information in which terminal information including terminal identification information (a terminal ID) of the terminal device 340 of the user is associated with vehicle identification information of the automobile 350. The vehicle information registration information is information in which vehicle information including the vehicle identification information of the automobile 350 is associated with the terminal ID of the terminal device 340 of the user.

Examples of the terminal ID include a portable phone number, an international mobile equipment identity (IMEI), an international mobile subscriber identity (IMSI), and an e-mail address. As an example of the seventh embodiment, the terminal ID is a portable phone number. As an example of the seventh embodiment, the vehicle identification information is a vehicle identification number (YIN). The terminal information is information including a portable phone number, the user's personal information (for example, a name, an address, an age, and the like), the user's preference information, and the like. The vehicle information is information including the VIN, destination information indicating the destination of the automobile 350, a travel log of the automobile 350, a log of information acquired from the communication network within the automobile 350 (an in-vehicle network acquisition information log), and the like.

The registration information storing unit 372 stores the terminal information registration information and the vehicle information registration information received by the registration information receiving unit 371. The search receiving unit 373 receives searches for the terminal information and the vehicle information stored in the registration information storing unit 372 and responds with search results.

The integrated database device 370 includes computer hardware such as a central processing unit (CPU) and a memory and a function of the integrated database device 370 is implemented by the CPU executing a computer program stored in the memory.

Also, the integrated database device 370 may be configured using a general-purpose computer device or may be configured as a dedicated hardware device.

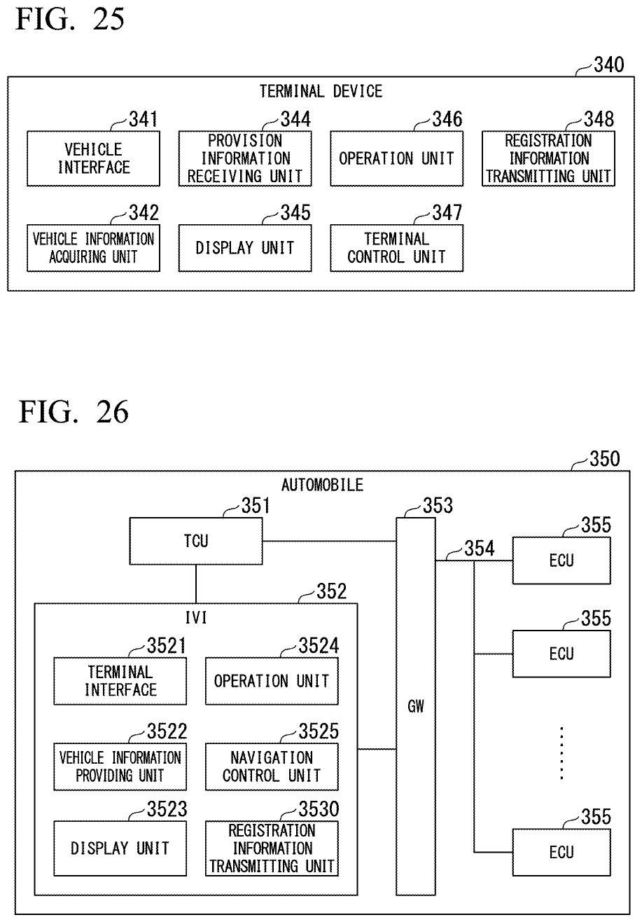

FIG. 25 is a block diagram showing a functional configuration example of the terminal device according to the seventh embodiment. FIG. 25 shows a functional configuration related to information provision of the terminal device 340. In FIG. 25, the terminal device 340 includes a vehicle interface 341, a vehicle information acquiring unit 342, a provision information receiving unit 344, a display unit 345, an operation unit 346, a terminal control unit 347, and a registration information transmitting unit 348.

The vehicle interface 341 communicates with the automobile 350 and cooperates with the terminal interface of the automobile 350. The vehicle interface 341 has a function of transmitting a terminal application screen generated by the application of the terminal device 340 to the automobile 350 and causing the terminal application screen to be displayed on the display device of the automobile 350 through the terminal interface of the automobile 350. Further, the vehicle interface 341 has a function of receiving vehicle information of the automobile 350 from the terminal interface of the automobile 350 and the like.

The vehicle information acquiring unit 342 acquires the vehicle information of the automobile 350 through the vehicle interface 341. The provision information receiving unit 344 receives the provision information distributed from the information distributing device 330.

The display unit 345 includes a display device for displaying data. The display unit 345 displays the provision information. As an example of the seventh embodiment, the display unit 345 displays the provision information received by the provision information receiving unit 344 from the information distributing device 330. The operation unit 346 includes an input device for inputting data according to an operation of the user. The display unit 345 and the operation unit 346 may be touch panels capable of performing both a data input operation and a data display operation.

The terminal control unit 347 controls the terminal device 340. The registration information transmitting unit 348 transmits information to be registered in the integrated database device 370.

The terminal device 340 includes computer hardware such as a CPU and a memory and a function of the terminal device 340 is implemented by the CPU executing a computer program stored in the memory. Also, the terminal device 340 may be configured using a general-purpose computer device or may be configured as a dedicated hardware device. Also, a portable communication terminal device such as a smartphone, a tablet-type computer device (a tablet PC), or the like may be used as the terminal device 340.

FIG. 26 is a block diagram showing a configuration of an automobile according to the seventh embodiment. FIG. 26 shows a configuration related to information provision of the automobile 350.

The automobile 350 includes a tele communication unit (TCU) 351, in-vehicle infotainment (IVI) equipment 352, a gateway (GW) device 353, a communication network 354, and a plurality of electronic control units (ECUs) 355.

The ECU 355 is an in-vehicle computer provided in the automobile 350. The ECU 355 has a control function such as engine control of the automobile 350. Examples of the ECU 355 include an ECU having an engine control function, an ECU having a transmission control function, an ECU having a steering wheel control function, and an ECU having a brake control function. The GW device 353 has a function of security of data applied to the ECU 355 mounted in the automobile 350.

The GW device 353 and the plurality of ECUs 355 are connected to a communication network (hereinafter referred to as an in-vehicle network) 354 provided in the automobile 350. The in-vehicle network 354 may be, for example, a controller area network (CAN). The CAN is known as an example of a communication network mounted in a vehicle. The GW device 353 exchanges data with each ECU 355 via the in-vehicle network 354. The ECU 355 exchanges data with another ECU 355 via the in-vehicle network 354.

Also, the automobile 350 is provided with a communication network other than the CAN as the in-vehicle network 354 and the exchange of data between the GW device 353 and the ECU 355 and the exchange of data between the ECUs 355 via the communication network other than the CAN may be performed. For example, a local interconnect network (LIN) may be provided in the automobile 350. Also, the CAN and the LIN may be provided in the automobile 350.

The TCU 351 is connected to the IVI equipment 352 and the GW device 353. The TCU 351 is a communication device. In the seventh embodiment, the TCU 351 performs communication using a wireless communication network. For example, the TCU 351 may communicate with the information distributing device 330 and the integrated database device 370 via the wireless communication network. For example, the TCU 351 may communicate with the terminal device 340 present inside or outside the automobile 350 via the wireless communication network.

The IVI equipment 352 includes, for example, a navigation function, a location information service function, a multimedia playback function for music, moving images, and the like, a voice communication function, a data communication function, an Internet connection function, and the like. The IVI equipment 352 is connected to the TCU 351 and the GW device 353. The IVI equipment 352 communicates with the ECU 355 via the GW device 353. Also, the IVI equipment 352 acquires vehicle information of the automobile 350 flowing through the in-vehicle network 354 via the GW device 353.

Also, the IVI equipment 352 has a short-range wireless communication function. For example, short-range wireless communication may be wireless communication of a wireless LAN such as “Wi-Fi (registered trademark)” or may be wireless communication of “Bluetooth (registered trademark)” such as BLE. The IVI equipment 352 may communicate with the terminal device 340 through the short-range wireless communication.

Also, the terminal device 340 and the IVI equipment 352 may be connected by a communication cable and the terminal device 340 and the IVI equipment 352 may transmit and receive data via the communication cable. For example, the terminal device 340 and the IVI equipment 352 may be connected by a universal serial bus (USB) cable and the terminal device 340 and the IVI equipment 352 may perform USB communication via the USB cable.

Also, the IVI equipment 352 may communicate with the terminal device 340, the information distributing device 330, and the integrated database device 370 via the TCU 351.

In FIG. 26, a functional configuration related to information provision of the IVI equipment 352 is shown. In FIG. 26, the IVI equipment 352 includes a terminal interface 3521, a vehicle information providing unit 3522, a display unit 3523, an operation unit 3524, a navigation control unit 3525, and a registration information transmitting unit 3530.

The terminal interface 3521 communicates with the terminal device 340 and works with the vehicle interface 341 of the terminal device 340. The terminal interface 3521 has a function of receiving a terminal application screen generated by the application of the terminal device 340 from the vehicle interface 341 and displaying the received terminal application screen on the display unit 3523, a function of transmitting the vehicle information of the automobile 350 to the vehicle interface 341, and the like.

For example, it is possible to transmit gear information, which is an example of the vehicle information of the automobile 350, to the terminal device 340 through the terminal interface 3521. The gear information is vehicle information indicating a state of a gear of a transmission of the automobile 350. The terminal device 340 can recognize whether or not the gear of the transmission of the automobile 350 is in a “parked” state on the basis of the gear information received from the automobile 350.

The vehicle information providing unit 3522 acquires the vehicle information of the automobile 350 flowing through the in-vehicle network 354 via the GW device 353. The vehicle information providing unit 3522 provides the vehicle information of the automobile 350 acquired via the GW device 353 to the terminal device 340 and the like.

The display unit 3523 includes a display device for displaying data. The operation unit 3524 includes an input device for inputting data according to the user's operation. The display unit 3523 and the operation unit 3524 may be touch panels capable of performing both a data input operation and a data display operation.

The navigation control unit 3525 controls the navigation function of the IVI equipment 352.

For example, the navigation control unit 3525 executes navigation on the basis of the navigation information received from the terminal device 340 through the terminal interface 3521. When the navigation information received from the terminal device 340 is destination information indicating a destination, the navigation control unit 3525 executes the navigation to the destination indicated by the destination information. When the navigation information received from the terminal device 340 is a navigation screen for the destination, the navigation control unit 3525 executes the navigation to the destination using the navigation screen.

The registration information transmitting unit 3530 transmits the information to be registered in the integrated database device 370.

The IVI equipment 352 includes computer hardware such as a CPU and a memory and a function of the IVI equipment 352 is implemented by the CPU executing a computer program stored in the memory.

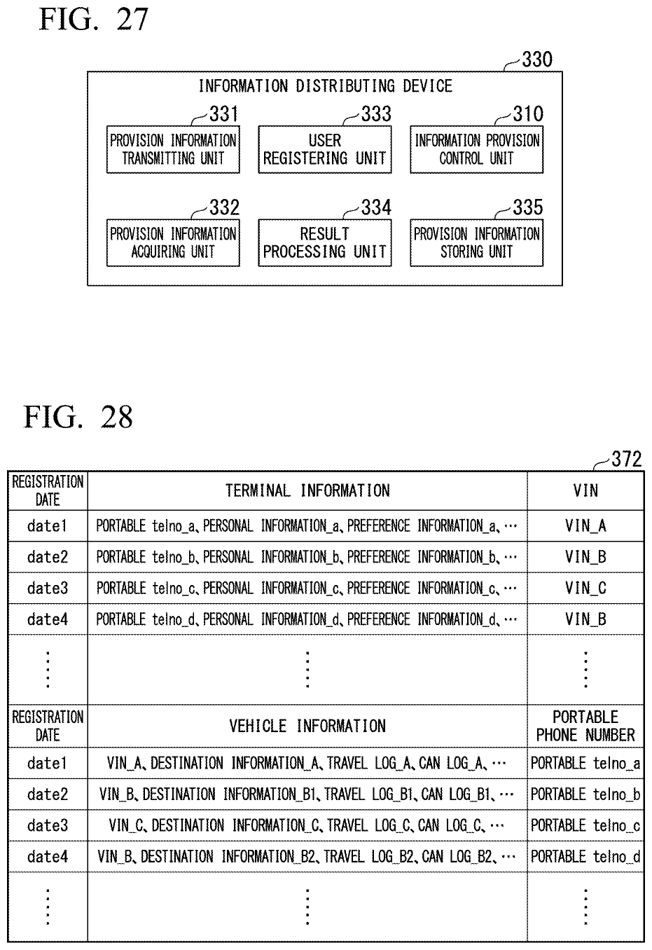

FIG. 27 is a block diagram showing a functional configuration example of the information distributing device according to the seventh embodiment. In FIG. 27, the information distributing device 330 includes an information provision control unit 310, a provision information transmitting unit 331, a provision information acquiring unit 332, a user registering unit 333, a result processing unit 334, and a provision information storing unit 335.

The information provision control unit 310 controls the distribution of provision information. The provision information transmitting unit 331 transmits the provision information on the basis of control of a transmission timing by the information provision control unit 310. The provision information transmitting unit 331 may transmit the provision information to the terminal device 340 or may transmit the provision information to the automobile 350. The provision information is, for example, information about electronic coupons and advertisements with benefits such as discounts that can be used in shops, introductions to service facilities such as gas stations and automobile maintenance shops, route guidance to service facilities, and the like.

The provision information acquiring unit 332 acquires the provision information to be distributed and retains the acquired provision information. The user registering unit 333 records user registration information of the user. The result processing unit 334 executes result processing for processing a result obtained as a result of distributing the provision information. The provision information storing unit 335 stores a plurality of pieces of provision information distributed for guiding customers.

The information distributing device 330 includes a computer hardware such as a central processing unit (CPU) and a memory and a function of the information distributing device 330 is implemented by the CPU executing a computer program stored in the memory. The information distributing device 330 may be configured using a general-purpose computer device or may be configured as a dedicated hardware device.

FIG. 28 is a table showing a configuration example of the registration information storing unit of the integrated database device according to the seventh embodiment. In FIG. 28, the registration information storing unit 372 stores the terminal information registration information and the vehicle information registration information received by the registration information receiving unit 371. The terminal information registration information is information in which terminal information including the portable phone number of the terminal device 340 of the user is associated with the VIN of the automobile 350. The vehicle information registration information is information in which vehicle information including the VIN of the automobile 350 is associated with the portable phone number of the terminal device 340 of the user.

As shown in FIG. 28, the terminal information is stored in the registration information storing unit 372 in association with the VIN. The vehicle information is stored in the registration information storing unit 372 in association with the portable phone number. The search receiving unit 373 can search for terminal information including the portable phone number of a search key and vehicle information associated with the portable phone number of the search key using the portable phone number of the terminal device 340 of the user as the search key. Also, the search receiving unit 373 can search for the vehicle information including the VIN of the search key and the terminal information associated with the VIN of the search key using the VIN of the automobile 350 of the user as the search key.

### [Database Generating Method]

Next, a database generating method according to the seventh embodiment will be described.

### Example 1 of Database Generating Method

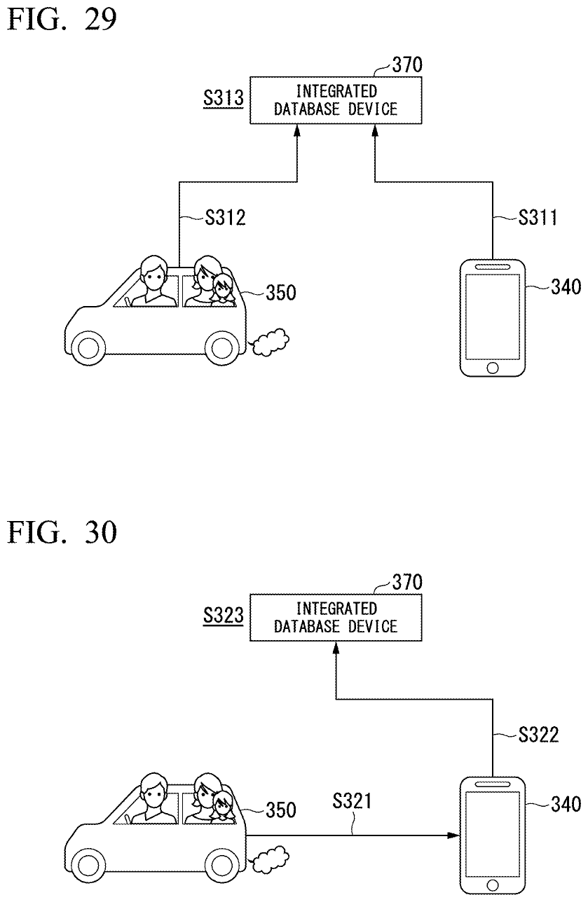

Example 1 of the database generating method according to the seventh embodiment will be described with reference to FIG. 29. FIG. 29 is a diagram showing a procedure of example 1 of the database generating method according to the seventh embodiment. The terminal device 340 communicates with the integrated database device 370 via the communication network NW1 and the communication network NW3. The automobile 350 communicates with the integrated database device 370 via the communication network NW2 and the communication network NW3.

(Step S311) The registration information transmitting unit 348 of the terminal device 340 transmits terminal information registration information to the integrated database device 370 at a predetermined timing. The predetermined timing is, for example, a periodic timing (for example, daily, weekly, or the like), a timing at which a predetermined application is started, or the like. The terminal information registration information is information including terminal information including the portable phone number of the terminal device 340 and the VIN of the automobile 350. The terminal information is retained in advance in the memory of the terminal device 340. The VIN of the automobile 350 may be retained in advance in the memory of the terminal device 340 or may be input by the user through the operation unit 346.

The registration information receiving unit 371 of the integrated database device 370 receives the terminal information registration information from the terminal device 340.

(Step S312) The registration information transmitting unit 3530 of the IVI equipment 352 of the automobile 350 transmits the vehicle information registration information to the integrated database device 370 at a predetermined timing. For example, the predetermined timing is a timing at which the automobile 350 is used such as a timing at which the ignition of the automobile 350 has been turned on. The vehicle information registration information is information including vehicle information including the VIN of the automobile 350 and the portable phone number of the terminal device 340. Vehicle information is retained in advance in the memory of the IVI equipment 352. The portable phone number of the terminal device 340 may be retained in advance in the memory of the IVI equipment 352 or may be input by the user through the operation unit 3524.

The registration information receiving unit 371 of the integrated database device 370 receives the vehicle information registration information from the automobile 350.

(Step S31.3) The registration information storing unit 372 of the integrated database device 370 stores the terminal information registration information received from the terminal device 340 by the registration information receiving unit 371. More specifically, as shown in FIG. 28, the registration information storing unit 372 stores the terminal information of the terminal information registration information in association with, for example, VIN_A of the terminal information registration information. This 110 terminal information includes a portable phone number (portable teino_a), personal information_a, preference information_a, and the like.

The registration information storing unit 372 of the integrated database device 370 stores the vehicle information registration information received from the terminal device 340 by the registration information receiving unit 371. More specifically, as shown in FIG. 28, the registration information storing unit 372 stores the vehicle information of the vehicle information registration information in association with, for example, the portable phone number (portable telno_a) of the vehicle information registration information. This vehicle information includes VIN_A, destination information_A, travel log_A, in-vehicle network acquisition information log (CAN log A), and the like.

According to example 1 of the database generating method, as shown in FIG. 28, it is possible to generate a database in which terminal information and vehicle information are integrated.

Also, in the information providing system 31 shown in FIG. 23, a terminal information database device, which stores only terminal information registration information, may be provided in the communication network NW I. Also, in the information providing system 31, a vehicle information database device, which stores only vehicle information registration information, may be provided in the communication network NW2. In this case, the registration information transmitting unit 348 of the terminal device 340 transmits the terminal information registration information to the terminal information database device. Also, the registration information transmitting unit 3530 of the IVI equipment 352 of the automobile 350 transmits the vehicle information registration information to the vehicle information database device. Next, the integrated database device 370 acquires the terminal information registration information from the terminal information database device. Also, the integrated database device 370 acquires the vehicle information registration information from the vehicle information database device.

### Example 2 of Database Generating Method

Example 2 of the database generating method according to the seventh embodiment will be described with reference to FIG. 30. FIG. 30 is a diagram showing a procedure of example 2 of the database generating method according to the seventh embodiment. The terminal device 340 communicates with the integrated database device 370 via the communication network NW1 and the communication network NW3. The terminal device 340 and the automobile 350 communicate with each other through, for example, short-range wireless communication.

(Step S321) The registration information transmitting unit 3530 of the IVI equipment 352 of the automobile 350 transmits the vehicle information including the VIN of the automobile 350 to the terminal device 340 at a predetermined timing. For example, the predetermined timing is a timing at which the automobile 350 is used such as a timing at which the ignition of the automobile 350 has been turned on. Vehicle information is retained in advance in the memory of the IVI equipment 352.

The terminal device 340 receives vehicle information from the automobile 350.

(Step S322) The registration information transmitting unit 348 of the terminal device 340 transmits the terminal information including the portable phone number of the terminal device 340 and the vehicle information received from the automobile 350 to the integrated database device 370 at a predetermined timing. The predetermined timing is, for example, a timing at which vehicle information has been received from the automobile 350. The terminal information is retained in advance in the memory of the terminal device 340.

The registration information receiving unit 371 of the integrated database device 370 receives the terminal information and the vehicle information from the terminal device 340. The terminal information and the vehicle information correspond to terminal information registration information in which the terminal information is associated with the YIN of the vehicle information and vehicle information registration information in which the vehicle information is associated with the portable phone number of the terminal information.

(Step S323) The registration information storing unit 372 of the integrated database device 370 stores the terminal information and the vehicle information received from the terminal device 340 by the registration information receiving unit 371. More specifically, as shown in FIG. 28, the registration information storing unit 372 stores the terminal information in association with, for example, VIN_A of the vehicle information. The terminal information includes a portable phone number (portable telno_a), personal information_a, preference information_a, and the like. Also, as shown in FIG. 28, the registration information storing unit 372 stores the vehicle information in association with the portable phone number (portable telno_a) of the terminal information. The vehicle information includes VIN_A, destination information_A, travel log_A, in-vehicle network acquisition information log (CAN log A), and the like.

According to example 2 of the database generating method, as shown in the example of FIG. 28, it is possible to generate a database in which terminal information and vehicle information are integrated.

### Example 3 of Database Generating Method

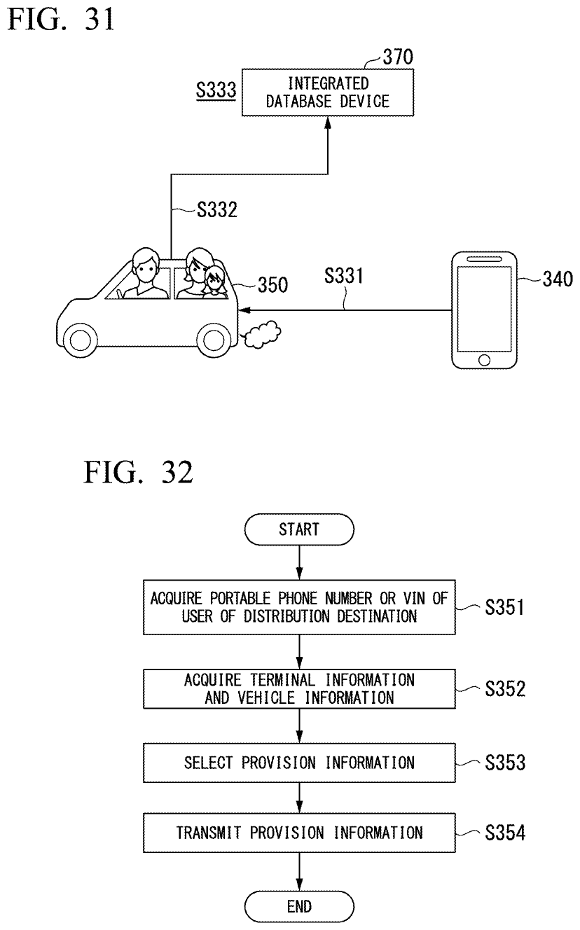

Example 3 of the database generating method according to the seventh embodiment will be described with reference to FIG. 31. FIG. 31 is a diagram showing a procedure of example 3 of the database generating method according to the seventh embodiment. The automobile 350 communicates with the integrated database device 370 via the communication network NW2 and the communication network NW3. The terminal device 340 and the automobile 350 communicate with each other through, for example, short-range wireless communication.

(Step S331) The registration information transmitting unit 348 of the terminal device 340 transmits the terminal information including the portable phone number of the terminal device 340 to the automobile 350 at a predetermined timing. The predetermined timing is, for example, a timing at which the terminal device 340 has established a communication connection with the automobile 350. The terminal information is retained in advance in the memory of the terminal device 340.

The automobile 350 receives the terminal information from the terminal device 340.

(Step S332) The registration information transmitting unit 3530 of the IVI equipment 352 of the automobile 350 transmits the vehicle information including the VIN of the automobile 350 and the terminal information received from the terminal device 340 to the integrated database device 370 at a predetermined timing. The predetermined timing is, for example, a timing at which the terminal information has been received from the terminal device 340. The vehicle information is retained in advance in the memory of the IVI equipment 352.

The registration information receiving unit 371 of the integrated database device 370 receives the terminal information and the vehicle information from the automobile 350. The terminal information and the vehicle information correspond to terminal information registration information in which the terminal information is associated with a VIN of the vehicle information and vehicle information registration information in which the vehicle information is associated with a portable phone number of terminal information.

(Step S333) The registration information storing unit 372 of the integrated database device 370 stores the terminal information and the vehicle information received from the automobile 350 by the registration information receiving unit 371. More specifically, as shown in FIG. 28, the registration information storing unit 372 stores the terminal information in association with, for example, VIN_A of the vehicle information. The terminal information includes a portable phone number (portable telno_a), personal information_a, preference information_a, and the like. Also, as shown in FIG. 28, the registration information storing unit 372 stores the vehicle information in association with the portable phone number (portable telno_a) of the terminal information. This vehicle information includes VIN_A, destination information_A, travel log_A, in-vehicle network acquisition information log (CAN log A), and the like.

According to example 3 of the database generating method, as shown in the example of FIG. 28, it is possible to generate a database in which the terminal information and the vehicle information are integrated.

### [Information Providing Method]

Next, an information providing method according to the seventh embodiment will be described with reference to FIG. 32. FIG. 32 is a flowchart showing a procedure of the information providing method according to the seventh embodiment. The information distributing device 330 communicates with the integrated database device 370 via the communication network NW3. The information distributing device 330 communicates with the terminal device 340 via the communication network NW3 and the communication network NW1. The information distributing device 330 communicates with the automobile 350 via the communication network NW3 and the communication network NW2.

The user performs user registration on the information distributing device 330 in advance. The user registering unit 333 of the information distributing device 330 records the user registration information acquired by the user registration of the user. The user registration information is information including a name, an address, a portable phone number of the terminal device 340, a YIN of the automobile 350, and the like. The user registering unit 333 of the information distributing device 330 may accept the user registration via a website.

A plurality of pieces of provision information are stored in advance in the provision information storing unit 335 of the information distributing device 330. The provision information stored in the provision information storing unit 335 is provision information distributed for guiding customers. The provision information is collected from shops, service facilities, and the like to which customers desire to be guided and is stored in the provision information storing unit 335. The provision information is, for example, information about electronic coupons and advertisements with benefits such as discounts that can be used in shops, introductions to service facilities such as gas stations and automobile maintenance shops, route guidance to service facilities, and the like.

(Step S351) The provision information acquiring unit 332 of the information distributing device 330 acquires the portable phone number or the VIN of the user of the distribution destination from the user registering unit 333. Here, as an example, the provision information acquiring unit 332 acquires a portable phone number (portable telno_a) of the user of the distribution destination from the user registering unit 333.

(Step S352) The provision information acquiring unit 332 transmits the portable phone number (portable telno_a) of the user of the distribution destination to the integrated database device 370 and requests an operation of searching for the terminal information and the vehicle information.

The search receiving unit 373 of the integrated database device 370 searches for the terminal information and the vehicle information using the portable phone number (portable telno_a) of the search request as a search key in response to the search request from the information distributing device 330. The terminal information to be searched for is the terminal information including the portable phone number (portable telno_a) of the search key. The vehicle information to be searched for is the vehicle information associated with the portable phone number (portable telno_a) of the search key. As a search result, the search receiving unit 373 acquires the terminal information and the vehicle information shown in the example of FIG. 28. This terminal information includes a portable phone number (portable telno_a), personal information_a, preference information_a, and the like. The vehicle information includes VIN_A, destination information_A, travel log_A, in-vehicle network acquisition information log (CAN log A), and the like. The search receiving unit 373 provides a response of a portable phone number (portable telno_a), personal information_a, preference information_a, and the like serving as the terminal information of the search result and VIN_A, destination information_A, travel log_A, in-vehicle network acquisition information log (CAN log A), and the like serving as the vehicle information to the information distributing device 330.

The provision information acquiring unit 332 of the information distributing device 330 receives a portable phone number (portable telno_a), personal information_a, preference information_a, and the like which are the terminal information and VIN_A, destination information_A, travel log_A, in-vehicle network acquisition information log (CAN log A), and the like which are vehicle information as a response to the search request from the integrated database device 370.

(Step S353) The provision information acquiring unit 332 of the information distributing device 330 selects provision information to be provided to the user of the distribution destination from a plurality of pieces of provision information of the provision information storing unit 35 on the basis of terminal information such as a portable phone number (portable telno_a), personal information_a, and preference information_a and vehicle information such as VIN_A, destination information_A, travel log_A, and an in-vehicle network acquisition information log (CAN log A) acquired from the integrated database device 370. The provision information selecting method will be described below.

(Step S354) The provision information transmitting unit 331 of the information distributing device 330 transmits the provision information selected by the provision information acquiring unit 332. The destination of the provision information may be the terminal device 340 of the user or may be the automobile 350 of the user.

Also, in the search example of the integrated database device 370 described above, the portable phone number (portable telno_a) of the user of the distribution destination has been used as the search key. The integrated database device 370 is similarly searched even if a search operation is performed using the YIN (VIN_A) of the user of the distribution destination as a search key. That is, even if the VIN (VIN_A) is used as the search key, the portable phone number (portable telno_a), personal information_a, preference information_a, and the like which are terminal information associated with VIN (VIN_A) and VIN_A, destination information_A, travel log_A, an in-vehicle network acquisition information log (CAN log A), and the like which are vehicle information including the YIN (VIN_A) shown in the example of FIG. 28 are searched for.

The provision information distributed to the user may be provided in the form of an information magazine (hereinafter referred to as a provision information magazine) including information about a plurality of recommended spots such as shops and facilities recommended to the user. The user can use detailed information, navigation information, and the like of the selected recommended spot by browsing the provision information magazine and selecting a desired recommended spot from the provision information magazine through the terminal device 340.

### [Provision Information Selecting Method]

Next, a provision information selecting method according to the seventh embodiment will be described.

The provision information is collected from advertisers of shops, service facilities, and the like and stored in the provision information storing unit 335 of the information distributing device 330. The provision information acquiring unit 332 of the information distributing device 330 selects the provision information to be provided to the user from the plurality of pieces of provision information stored in the provision information storing unit 335.

When the provision information is selected, it is possible to use the vehicle information of the automobile 350 of the VIN of the registered user and the terminal information of the terminal device 340 of the terminal ID (for example, a portable phone number or the like) of the registered user. The provision information acquiring unit 332 designates the user's VIN or terminal ID (for example, a portable phone number or the like) as a search key and acquires vehicle information and terminal information related to the user from the integrated database device 370.

The provision information acquiring unit 332 selects the provision information to be provided to the user from among the plurality of pieces of provision information stored in the provision information storing unit 335 on the basis of the vehicle information and the terminal information related to the user acquired from the integrated database device 370. Also, the provision information acquiring unit 332 may select the provision information to be provided to the user from among the plurality of pieces of provision information stored in the provision information storing unit 335 on the basis of either the vehicle information or the terminal information related to the user acquired from the integrated database device 370.

The vehicle information and the terminal information that can be used when the provision information is selected will be described below.

### (Vehicle Information)

An example of vehicle information that can be used when the provision information is selected is shown below.

(1) Vehicle identification number (VIN) of the automobile 350.

(2) Personal information such as a name, an address, and an age collected when the automobile 350 is purchased.

(3) Destination information indicating a destination set in the navigation function of the IVI equipment 352 of the automobile 350. For example, by selecting provision information about advertisements, coupons, and the like for shops suitable for stopping by such as restaurants on a route to the destination using the destination information, the customer guiding effect for the shops can be expected.

(4) Travel log. The travel log includes the following information.

(4-1) Continuous traveling time. For example, by selecting provision information about an introduction to a facility of a rest spot and route guidance thereto for the user of the automobile 350 who has been driving for a long time (a predetermined time or more) using the continuous traveling time, the customer guiding effect for the facility of the rest spot can be expected.

(4-2) Driving log. For example, it is possible to estimate a degree of fatigue of the user from driving information such as a location, a vehicle speed, a brake, and a steering angle of the automobile 350 using the driving log. By selecting the provision information about an introduction to a facility of a rest spot, route guidance thereto, and the like in accordance with an estimation result, the customer guiding effect for the facility of the rest spot can be expected. For example, it is determined whether or not the driving information has changed drastically (whether or not a frequency at which the driving information changes is greater than or equal to a predetermined value) and provision information about an introduction to a facility of a rest spot or route guidance is selected when the driving information has changed drastically.

(5) Log of information acquired from the in-vehicle network 354 such as a CAN. This type of information log includes the following information.

(5-1) Remaining amount of fuel. For example, by selecting the provision information about an introduction to a gas station or route guidance thereto with respect to the user of the automobile 350 having the low remaining amount of fuel (the remaining amount of fuel less than or equal to a predetermined amount) using information of the remaining amount of fuel, the customer guiding effect for the gas station can be expected.

(5-2) ECU error message. By selecting provision information about introductions to a regular dealer of the automobile 350 and an automobile maintenance shop, route guidance thereto, and the like on the basis of the error message (the ECU error message) generated by the ECU 355 of the automobile 350, the customer guiding effect for the regular dealer and the automobile maintenance shop can be expected. For example, when a predetermined type of ECU error message has occurred among a plurality of types of ECU error messages generated in various types of ECUs 355 of the automobile 350, provision information about an introduction to a regular dealer of the automobile 350 and an automobile maintenance shop, route guidance thereto, and the like is selected.

### (Terminal Information)

An example of terminal information that can be used when the provision information is selected is shown below.

(1) Personal information such as a name, an address, and an age collected when the terminal device 340 is purchased.

(2) Terminal ID. Examples of the terminal ID include a portable phone number, an international mobile equipment identity (IMEI), an international mobile subscriber identity (IMSI), and an e-mail address.

(3) Preference information. This preference information includes the following.

(3-1) Usage frequency and usage time of the application of the terminal device 340.

(3-2) Advertisement browsing history showing advertisements browsed through an operation of the user among advertisements presented by the application of the terminal device 340.

(3-3) Action history indicating an action of the user acquired from a movement history of the terminal device 340 such as a location of the terminal device 340.

### Example 1 of Provision Information Selecting Method

Example 1 of the provision information selecting method will be described. The provision information acquiring unit 332 selects the provision information to be provided to the user from among the plurality of pieces of provision information stored in the provision information storing unit 335 on the basis of the vehicle information and the terminal information related to the user acquired from the integrated database device 370. Here, an example of the terminal information related to the user acquired from the integrated database device 370 will be given and example 1 (examples 1-1 to 1-5) of the provision information selecting method will be described. In the following example of the provision information selecting method, examples of the terminal information include a portable phone number (portable telno_a), personal information_a, and preference information_a. Examples of the vehicle information include VIN_A, destination information_A, travel log_A, and an in-vehicle network acquisition information log (CAN log A).

### Example 1-1 of Provision Information Selecting Method

The provision information acquiring unit 332 extracts a candidate for provision information to be provided to the user (hereinafter referred to as a provision information candidate) from among a plurality of pieces of provision information stored in the provision information storing unit 335 according to personal information_a “user's name, address, and age.” An example of a provision information candidate extracting method will be given. In the plurality of pieces of provision information stored in the provision information storing unit 335, there is provision information having a customer guiding candidate condition set by the advertiser. Personal information of the user is an example of a customer guiding candidate condition. The provision information acquiring unit 332 extracts the provision information having the customer guiding candidate condition corresponding to personal information_a as the provision information candidate.

### Example 1-2 of Provision Information Selecting Method

The provision information acquiring unit 332 extracts the provision information candidate from the plurality of pieces of provision information stored in the provision information storing unit 335 according to preference information_a. An example of this provision information candidate extracting method will be given.

For example, the provision information acquiring unit 332 extracts provision information of an advertisement presented by the application having a usage frequency or usage time of the application included in preference information_a greater than or equal to a predetermined amount as the provision information candidate. Alternatively, the provision information acquiring unit 332 extracts provision information of an advertisement similar to that of an advertisement browsing history included in preference information_a as the provision information candidate. Alternatively, the provision information acquiring unit 332 extracts the provision information corresponding to the user's action indicated in an action history included in preference information_a, for example, provision information corresponding to a shop or service facility used by the user, as the provision information candidate.

### Example 1-3 of Provision Information Selecting Method

The provision information acquiring unit 332 extracts the provision information candidate from the plurality of pieces of provision information stored in the provision information storing unit 335 according to destination information_A. An example of this provision information candidate extracting method will be given. The provision information acquiring unit 332 extracts provision information about advertisements and coupons of shops, service facilities, and the like suitable for stopping by on a predetermined route to a destination indicated by destination information_A as the provision information candidate.

### Example 1-4 of Provision Information Selecting Method

The provision information acquiring unit 332 extracts the provision information candidate from the plurality of pieces of provision information stored in the provision information storing unit 335 according to travel log_A. An example of this provision information candidate extracting method will be given.

For example, when a continuous traveling time included in travel log_A is greater than or equal to a predetermined time, the provision information acquiring unit 332 extracts provision information about an introduction to a facility of a rest spot, route guidance, and the like as the provision information candidate. Alternatively, the provision information acquiring unit 332 determines whether or not a frequency at which driving information such as a location, a vehicle speed, a brake, and a steering angle of the automobile 350 is greater than or equal to a predetermined value in the driving log included in travel log_A and extracts provision information about an introduction to a facility of a rest spot, route guidance, and the like as the provision information candidate when the frequency of the change in the driving information is greater than or equal to the predetermined value.

### Example 1-5 of Provision Information Selecting Method

The provision information acquiring unit 332 extracts the provision information candidate from a plurality of pieces of provision information stored in the provision information storing unit 335 according to the in-vehicle network acquisition information log (CAN log A). An example of this provision information candidate extracting method will be given. For example, the provision information acquiring unit 332 extracts provision information about an introduction to a gas station, route guidance, and the like as the provision information candidate when the remaining amount of fuel included in CAN log A is less than or equal to a predetermined amount. Alternatively, when the ECU error message included in CAN log A is a predetermined type of ECU error message, the provision information acquiring unit 332 extracts information about an introduction to a regular dealer of the automobile 350, an automobile maintenance shop, route guidance, and the like as the provision information candidate.

The provision information acquiring unit 332 may execute only one of the above-described examples 1-1 to 1-5 of the provision information selecting method or may execute two or more thereof. The provision information acquiring unit 332 selects a provision information candidate of the extraction result as the provision information to be provided to the user.

When a plurality of pieces of provision information to be provided to the user are selected, the provision information acquiring unit 332 may generate a provision information magazine including the plurality of pieces of provision information. In this case, the provision information transmitting unit 331 transmits the provision information magazine generated by the provision information acquiring unit 332.

Also, when two or more of examples 1-1 to 1-5 of the provision information selecting method are executed, the provision information acquiring unit 332 may further narrow down the provision information candidates of the extraction results and select narrowing-down results as provision information to be provided to the user.

For example, the provision information acquiring unit 332 may perform narrowing-down from provision information candidates of the extraction results of examples 1-2 to 1-5 of the provision information selecting method to only provision information candidates that overlap provision information candidates of extraction results of example 1-1 of the provision information selecting method (provision information candidates of extraction results based on the user's personal information) and select narrowing-down results as provision information to be provided to the user.

Alternatively, the provision information acquiring unit 332 may perform narrowing-down from provision information candidates of the extraction results of examples 1-3 to 1-5 of the provision information selecting method to only provision information candidates that overlap provision information candidates of extraction results of example 1-2 of the provision information selecting method (provision information candidates of extraction results based on preference information) and select narrowing-down results as provision information to be provided to the user.

Alternatively, provision information acquiring unit 332 may perform narrowing-down from provision information candidates of the extraction results of examples 1-3 to 1-5 of the provision information selecting method to only provision information candidates that overlap the provision information candidates of the extraction results of example 1-1 of the provision information selecting method (the provision information candidates of the extraction results based on the user's personal information) and that overlap the provision information candidates of the extraction results of example 1-2 of the provision information selecting method (the provision information candidates of the extraction results based on the preference information) and select narrowing-down results as provision information to be provided to the user.

Alternatively, the provision information acquiring unit 332 may perform narrowing-down from provision information candidates of the extraction results of examples 1-4 and 1-5 of the provision information selecting method to only provision information candidates that overlap provision information candidates of extraction results of example 1-3 of the provision information selecting method (provision information candidates of extraction results based on destination information) and select narrowing-down results as provision information to be provided to the user.

### Example 2 of Provision Information Selecting Method

Example 2 of the provision information selecting method will be described. The same automobile 350 may be used by a plurality of users. For example, in a car sharing service, a plurality of users may alternately use the same automobile 350 in the same period. Also, in a rental car service, users who use the same automobile 350 change with the passage of time. In consideration of such circumstances, in example 2 of the provision information selecting method, when the same automobile 350 is used by a plurality of users, an operation of appropriately selecting the provision information to be distributed to the users of the automobile 350 is attempted.

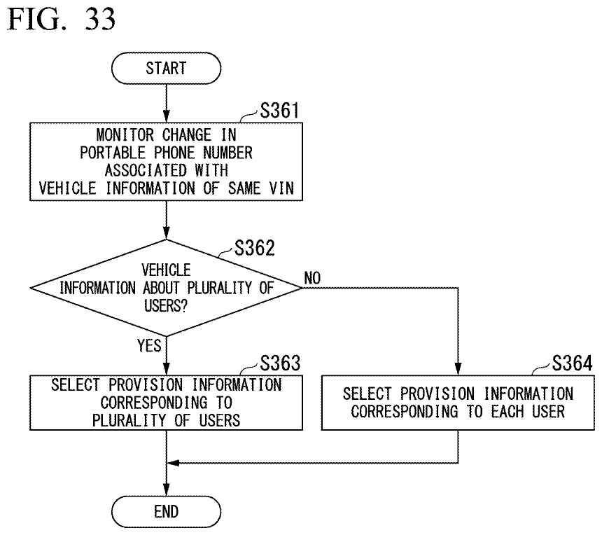

Example 2 of the provision information selecting method according to the seventh embodiment will be described with reference to FIG. 33. FIG. 33 is a flowchart showing the procedure of example 2 of the provision information selecting method according to the seventh embodiment.

(Step S361) The provision information acquiring unit 332 monitors a change in a portable phone number associated with vehicle information including the same VIN stored in the registration information storing unit 372 of the integrated database device 370. The monitoring is performed by transmitting a request from the provision information acquiring unit 332 to the search receiving unit 373 of the integrated database device 370. In the example of FIG. 28, portable phone numbers associated with the vehicle information including the same VIN (VIN_B) include a portable phone number (portable telno_b) and a portable phone number (portable telno_d).

(Step S362) The provision information acquiring unit 332 determines whether or not vehicle information of a monitoring target is vehicle information related to a plurality of users on the basis of monitoring results. In the example of FIG. 28, it is determined whether or not the vehicle information including the same VIN (VIN_B) is vehicle information related to a plurality of users. This determination method will be described.

When there are a plurality of portable phone numbers such as portable telno_b and portable telno_d associated with vehicle information including the same VIN (VIN_B), a case in which “portable telno_b” and “portable telno_d” are associated with vehicle information alternately and repeatedly including the same VIN (VIN_B) within a certain period of time, for example, one week, is considered. In this case, because it is considered that the automobile 350 is alternately and repeatedly used by a plurality of users (a user of portable telno_b and a user of portable telno_d) in the same period according to the car sharing service, it is determined that vehicle information including the VIN (VIN_B) is vehicle information about the plurality of users. This is because, in the case of the car sharing service, it is assumed that the vehicle information is not reset even if the user of the automobile 350 changes.

On the other hand, when there are a plurality of portable phone numbers such as portable telno_b and portable telno_d associated with vehicle information including the same VIN (VIN_B), a case in which “portable telno_b” and “portable telno_d” are not associated with vehicle information alternately and repeatedly including the same YIN (VIN_B) within a certain period of time, for example, one week, is also considered. In this case, for example, when only “portable telno_b” is associated with the vehicle information including the VIN (VIN_B) in the first week of the same month and only “portable telno_d” is associated with the vehicle information including the VIN (VIN_B) in the next week, it is considered that the automobile 350 is first used by the user of portable telno_b according to the car rental service and is subsequently used by the user of portable telno_d. Therefore, in this case, it is determined that the vehicle information including the VIN (VIN_B) is not the vehicle information related to a plurality of users. This is because, in the case of the rental car service, it is assumed that the vehicle information is reset when the user of the automobile 350 changes with the passage of time.

(Step S363) The provision information acquiring unit 332 selects provision information corresponding to a plurality of users from a plurality of pieces of provision information of the provision information storing unit 335 on the basis of the vehicle information including the VIN (VIN_B). An example of a method of selecting provision information corresponding to a plurality of users will be given. For example, provision information corresponding to a plurality of unspecified users is selected. Alternatively, provision information corresponding to a plurality of specified users (a user of portable telno_b and a user of portable telno_d) is selected.

(Step S364) The provision information acquiring unit 332 selects user-specific provision information corresponding to each user from the plurality of pieces of provision information of the provision information storing unit 335 on the basis of the vehicle information including the VIN (VIN_B). In this case, user-specific provision information of portable telno_b is selected on the basis of the vehicle information including the VIN (VIN_B) associated with the portable phone number (portable telno_b). Also, user-specific provision information of portable telno_d is selected on the basis of the vehicle information including the VIN (VIN_B) associated with the portable phone number (portable telno_d).

According to example 2 of the provision information selecting method described above, when the same automobile 350 is used by a plurality of users, provision information to be distributed to the users of the automobile 350 can be appropriately selected.

### [Application Example of Information Providing System]

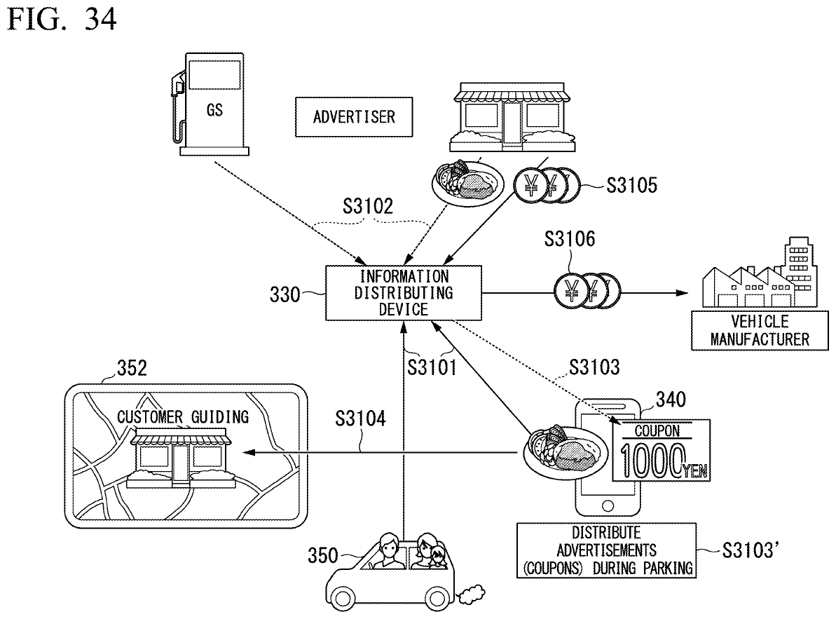

Next, an application example of the information providing system 31 according to the seventh embodiment will be described. In the present application example, a customer guiding business model, which is an application example of the above-described information providing system 1, is implemented. FIG. 34 is a configuration diagram showing an application example of the information providing system according to the seventh embodiment. Hereinafter, an application example of the information providing system 31 according to the seventh embodiment will be described with reference to FIG. 34.

In the application example of the information providing system 31 shown in FIG. 34, the provision information is used to guide customers for advertisers of shops such as restaurants, service facilities such as gas stations, and the like. The automobile 350 is a customer guiding tool for use in guiding customers. The user possesses a terminal device 340 and is in the customer guiding tool (the automobile) 350. The user may be a driver of the customer guiding tool (the automobile) 350 or may be a fellow passenger of the customer guiding tool (the automobile) 350 who is not the driver.

(Step S3101) The information distributing device 330 acquires preference information indicating the user's preference transmitted from the terminal device 340 of a terminal ID of a registered user from the integrated database device 370 (not shown in FIG. 34). The user registering unit 333 of the information distributing device 330 includes the acquired preference information in user registration information of the user and records the user registration information.

The information distributing device 330 acquires a travel log of the automobile 350 transmitted from the automobile 350 of a VIN of the registered user from the integrated database device 370. The user registering unit 333 of the information distributing device 330 includes the acquired travel log in the user registration information of the user and records the user registration information.

(Step S3102) The provision information acquiring unit 332 of the information distributing device 330 collects provision information about advertisements, coupons, and the like from an advertiser. The provision information storing unit 335 of the information distributing device 330 stores the collected provision information.

(Step S3103) The information distributing device 330 distributes the provision information to the terminal device 340 through the provision information transmitting unit 331. Here, the information to be provided to the user is presented in accordance with control of the information provision control unit 310 of the information distributing device 330. In the example of FIG. 34, information indicating whether or not the customer guiding tool (the automobile) 350 has parked is transmitted from the customer guiding tool (the automobile) 350 to the information distributing device 330. The information distributing device 330 distributes provision information about advertisements, coupons, and the like to the terminal device 340 when the customer guiding tool (the automobile) 350 has parked so that the distribution does not interfere with the driving of the customer guiding tool (the automobile) 350 (S3103′). The provision information is displayed on the terminal device 340. The provision information about advertisements, coupons, and the like presented to the user through the terminal device 340 has the customer guiding effect of guiding a person (a customer) who is in the customer guiding tool (the automobile) 350 to the advertiser's shop or service facility.

(Step S3104) The vehicle interface 341 of the terminal device 340 transmits an address of the advertiser's shop or service facility included in the provision information about advertisements, coupons, and the like to the customer guiding tool (the automobile) 350. When the IVI equipment 352 of the customer guiding tool (the automobile) 350 receives the address of the advertiser's shop or service facility through the terminal interface 3521, route guidance to the advertiser's shop or service facility is performed through the navigation function of the IVI equipment 352. Thereby, the customer visits the advertiser's shop or service facility through the customer guiding tool (the automobile) 350. The customer can receive benefits such as discounts by presenting advertisements and coupons for provision information in the advertiser's shop or service facility.

(Step S3105) The advertiser pays a result fee according to an advertisement of provision information and a customer guiding record by the coupon to an operator of the information providing system. A notification of payment information of the result fee is provided to the result processing unit 334 of the information distributing device 330.

(Step S3106) The result processing unit 334 executes a process of distributing the result fee indicated by the payment information of the result fee in accordance with a predetermined result processing method. In the example of FIG. 34, the result fee is distributed to a vehicle manufacturer of the automobile 350 which is a customer guiding tool.

According to the above-described embodiment, because the terminal information and the vehicle information are stored in association with each other by the integrated database device 370, it is possible to efficiently acquire the terminal information and the vehicle information to be referred to when the provision information about coupons and the like suitable for an occupant of the automobile is selected. Also, it is possible to select the provision information about coupons and the like suitable for the occupant of the automobile on the basis of the terminal information and the vehicle information acquired from the integrated database device 370. Thereby, because a degree of user suitability of the provision information provided to the user is improved, the effect of contributing to the improvement of the customer guiding effect according to provision information about coupons and the like can be obtained.

Although embodiments of the present invention have been described above in detail with reference to the drawings, specific configurations are not limited to the embodiments and design changes and the like may also be included without departing from the scope of the present invention.

Although an automobile is taken as an example as a vehicle in the above-described embodiment, the present invention can also be applied to motorized bicycles and vehicles such as railway vehicles other than automobiles.

Also, a computer program for implementing functions of each device described above may be recorded on a computer-readable recording medium and a computer system may be allowed to read and execute the program recorded on the recording medium. Also, the “computer system” described here may include an operating system (OS) and hardware such as peripheral devices.

Also, the “computer-readable recording medium” refers to a storage device including a flexible disk, a magneto-optical disc, a read only memory (ROM), a writable non-volatile memory such as a flash memory, a portable medium such as a digital versatile disc (DVD), and a hard disk embedded in the computer system.

Furthermore, the “computer-readable recording medium” is assumed to include a medium that retains a program for a fixed period of time, such as a volatile memory (for example, a dynamic random access memory (DRAM)) inside a computer system serving as a server or a client when the program is transmitted via a network such as the Internet or a communication circuit such as a telephone circuit.

Also, the above-described program may be transmitted from a computer system storing the program in a storage device or the like via a transmission medium or transmitted to another computer system by transmission waves in a transmission medium. Here, the “transmission medium” for transmitting the program refers to a medium having a function of transmitting information, such as a network (a communication network) like the Internet or a communication circuit (a communication line) like a telephone circuit.

Also, the above-described program may be a program for implementing some of the above-described functions.

Further, the above-described program may be a program capable of implementing the above-described functions in combination with a program already recorded on the computer system, i.e., a so-called differential file (differential program).

### REFERENCE SIGNS LIST

11a, 11b Information providing system
110 Information provision control unit
111 Parking state information receiving unit
112 Provision control unit
113 User type information acquiring unit
130, 130a, 130b Information distributing device
131 Provision information transmitting unit
132 Provision information acquiring unit
133 User registering unit
134 Result processing unit
140, 140a, 140b Terminal device
141 Vehicle interface
142 Vehicle information acquiring unit
143 Parking state information transmitting unit
144 Provision information receiving unit
145 Display unit
150 Automobile
151 TCU
152 IVI equipment
153 GW device
154 In-vehicle network
155 ECU
1521 Terminal interface
1522 Vehicle Information providing unit
21a, 21b Information providing system
210 Information provision control unit
230 Information distributing device
231 Provision information transmitting unit
232 Provision information acquiring unit
233 User registering unit
234 Result processing unit
240a, 240b Terminal device
241 Vehicle interface
242 Vehicle information acquiring unit
244, 2526 Provision information receiving unit
245, 2523 Display unit
246, 2524 Operation unit
247 Terminal control unit
250 Automobile
251 TCU
252a, 252b IVI equipment
253 GW device
254 In-vehicle network
255 ECU
2521 Terminal interface
2522 Vehicle information providing unit
2525 Navigation control unit
31 Information providing system
310 Information provision control unit
330 Information distributing device
331 Provision information transmitting unit
332 Provision information acquiring unit
333 User registering unit
334 Result processing unit
335 Provision information storing unit
340 Terminal device
341 Vehicle interface
342 Vehicle information acquiring unit
344 Provision information receiving unit
345, 3523 Display unit
346, 3524 Operation unit
347 Terminal control unit
348, 3530 Registration information transmitting unit
350 Automobile
351 TCU
352 IVI equipment
353 GW device
354 In-vehicle network
355 ECU
3521 Terminal interface
3522 Vehicle information providing unit
3525 Navigation control unit
370 Integrated database device
371 Registration information receiving unit
372 Registration information storing unit
373 Search receiving unit
NW1, NW2, NW3 Communication network

1. An information providing system comprising:
a terminal device; and
an information distributing device,
wherein the information distributing device includes a provision information transmitting unit configured to transmit provision information to be provided to a user of the terminal device to the terminal device, and
wherein the terminal device includes
a vehicle interface configured to communicate with a vehicle;
a vehicle information acquiring unit configured to acquire parking state information indicating whether or not the vehicle has parked through the vehicle interface; and
a provision control unit configured to control whether or not the provision information is to be displayed on a display screen of the terminal device on the basis of the parking state information.

2. An information providing system comprising:
a terminal device; and
an information distributing device,
wherein the terminal device includes
a vehicle interface configured to communicate with a vehicle;
a vehicle information acquiring unit configured to acquire parking state information indicating whether or not the vehicle has parked through the vehicle interface; and
a parking state information transmitting unit configured to transmit the parking state information to the information distributing device, and
wherein the information distributing device includes
a provision information transmitting unit configured to transmit provision information to be provided to a user of the terminal device to the terminal device; and
a provision control unit configured to control whether or not the provision information is to be displayed on a display screen of the terminal device on the basis of the parking state information.

3. The information providing system according to claim 2, wherein the provision control unit controls a transmission timing at which the provision information transmitting unit transmits the provision information to the terminal device.

4. The information providing system according to claim 1, further comprising a user type information acquiring unit configured to acquire user type information indicating whether or not the user is a driver of the vehicle,
wherein the provision control unit performs control so that the provision information is not displayed on the display screen of the terminal device when the parking state information indicates that the vehicle has not parked if the user type information indicates that the user is the driver of the vehicle.

5.-10. (canceled)

11. A terminal device comprising:
a vehicle interface configured to communicate with a vehicle; and
a terminal control unit configured to transmit navigation information on a basis of provision information to the vehicle through the vehicle interface when a user operation of selecting the provision information distributed from an information distributing device to the terminal device has been received.

12. The terminal device according to claim 11, wherein the terminal control unit causes the navigation information to be displayed on a display screen of the terminal device when a communication connection with the vehicle through the vehicle interface has not been established.

13. The terminal device according to claim 11, wherein the navigation information is information including a destination identified by location information included in the provision information.

14. The terminal device according to claim 13, wherein the navigation information is a screen for navigation to the destination.

15.-27. (canceled)
